(19) United States
(12) Patent Application Publication
(10) Pub. No.: US 2012/0315551 A1
(43) Pub. Date: Dec. 13, 2012

(54) Materials for Battery Electrolytes and Methods for Use

(75) Inventors: Vinay V. BHAT, San Diego, CA (US); Gang CHENG, San Diego, CA (US); Steven KAYE, San Diego, CA (US); Bin LI, San Diego, CA (US); Risa OLUGBILE, San Diego, CA (US); Jen Hsien YANG, San Diego, CA (US)

(73) Assignee: WILDCAT DISCOVERY TECHNOLOGIES, INC., San Diego, CA (US)

(21) Appl. No.: 13/459,515

(22) Filed: Apr. 30, 2012

Related U.S. Application Data
(60) Provisional application No. 61/495,318, filed on Jun. 9, 2011.
(60) Provisional application No. 61/543,262, filed on Oct. 4, 2011.

(51) Int. Cl. H01M 10/056; H01M 10/04

(52) U.S. Cl. 429/339; 429/207; 429/340; 429/341; 29/623.1; 29/623.2

(57) ABSTRACT

Described herein are materials for use in electrolytes that provide a number of desirable characteristics when implemented within batteries, such as high stability during battery cycling up to high temperatures high voltages, high discharge capacity, high coulombic efficiency, and excellent retention of discharge capacity and coulombic efficiency over several cycles of charging and discharging. In some embodiments, a high voltage electrolyte includes a base electrolyte and a set of additive compounds, which impart these desirable performance characteristics.

This application claims priority to and the benefit of each of the following applications: U.S. Provisional Application No. 61/495,318 filed Jun. 9, 2011 entitled “Battery Electrolytes for High Voltage Cathode Materials” and U.S. Provisional Application No. 61/543,262 filed Oct. 4, 2011 entitled “Battery Electrolytes for High Voltage Cathode Materials”; each of which applications is incorporated herein by reference.

### BACKGROUND OF THE INVENTION

The invention relates generally to battery electrolytes. More particularly, the invention relates to battery electrolytes to improve stability of batteries, such as one or more of high voltage stability, thermal stability, electrochemical stability, and chemical stability.

An electrolyte serves to transportions and prevent electrical contact between electrodes in a battery. Organic carbonate-based electrolytes are most commonly used in lithium-ion (“Li-ion”) batteries, and, more recently, efforts have been made to develop new classes of electrolytes based on sulfones, silanes, and nitriles. Unfortunately, these conventional electrolytes typically cannot be operated at high voltages, since they are unstable above 4.5 V or other high voltages. At high voltages, conventional electrolytes can decompose, for example by catalytic oxidation in the presence of cathode materials, to produce undesirable products that affect both the performance and safety of a battery.

In the case of Li-ion batteries, cobalt and nickel-containing phosphates, fluorophosphates, fluorosulphates, spinels, and silicates have been reported to have higher energy densities than LiFePO₄, LiMn₂O₄, and other commonly used cathode materials. However, these cathode materials also have redox potentials greater than 4.5 V, allowing for operation of the battery at higher voltages but also possibly causing severe electrolyte decomposition in the battery. In order to use a cathode material to deliver a higher energy density at a higher voltage platform, the hurdle of electrolyte decomposition should be addressed at least up to, or above, a redox potential of the cathode material.

Another problem with both organic carbonate-based electrolytes and other classes of electrolytes is chemical stability at elevated temperatures. Even at low voltages, elevated temperatures can cause conventional electrolytes to decompose, for example, by catalytic oxidation in the presence of cathode materials, to produce undesirable products that affect both performance and safety of a battery.

It is against this background that a need arose to develop the electrolytes and related methods and systems described herein. Certain embodiments of the inventions disclosed herein address these and other challenges.

### BRIEF SUMMARY

Certain embodiments of the invention are directed to an electrolyte and an electrolyte solution for a high voltage battery. Certain embodiments of the invention are directed to a battery including an anode having an anode active material characterized by a first specific capacity, a cathode having a cathode active material characterized by a second specific capacity and an electrolyte comprising a lithium salt, a non-aqueous solvent, and a compound that promotes the electrochemical stability of the electrolyte.

The first specific capacity and the second specific capacity are matched such that the battery is characterized by a rated charge voltage greater than about 4.2 V. In certain embodiments, the battery includes a cathode active material that is characterized by a specific capacity of at least about 10 mAh/(g of active material) upon discharge at a current of about 0.01C over a voltage range of about 4.9 V to about 4.2 V. In certain embodiments, the battery has a coulombic efficiency at 100 cycles from an initial cycle of at least about 90% when the battery is operated in an environment at a temperature of about 50 degrees Celsius.

Other embodiments of the invention are directed to methods of forming, conditioning, and operating a battery including such high voltage and high temperature electrolyte solutions. For example, methods of operating or using a battery can include providing the battery, and cycling such battery to supply power for consumer electronics, portable electronics, hybrid vehicles, electrical vehicles, power tools, power grid, military applications, and aerospace applications. For example, methods of forming a battery can include providing an anode, providing a cathode, and providing an electrolyte solution facilitating the flow of current between the anode and the cathode. The electrolyte can include an electrolyte solution of certain embodiments of the invention. The methods of forming the battery can also include converting a stabilizing additive compound of the electrolyte into a derivative thereof.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE SEVERAL VIEWS OF THE DRAWINGS

FIG. 1 illustrates a Li-ion battery implemented in accordance with an embodiment of the invention.

FIG. 2 illustrates the operation of a Li-ion battery and a graphical representation of an illustrative non-limiting mechanism of action of an electrolyte including an additive compound, according to an embodiment of the invention.

FIG. 3A and FIG. 3B set forth performance characteristics measured for battery cells including various stabilizing additives, according to an embodiment of the invention.

FIGS. 4 through 10 compare capacity retention with and without various additive compounds over several cycles, according to embodiments of the invention.

FIGS. 11 through 15 set forth residual current measurements for various additives at a constant voltage at 50° C., according to an embodiment of the invention.

FIG. 16 compares coulombic efficiency of battery cells with and without various additives at the first cycle.

FIGS. 17 through 20 compare capacity retention of the battery cells with and without various additives over several cycles, expressed in terms of a percentage of an initial specific capacity upon discharge retained at a particular cycle, according to an embodiment of the invention.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

As used herein, the singular terms “a,” “an,” and “the” include the plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common characteristics.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the term “sub-micron range” refers to a general range of dimensions less than about 1 μm or less than about 1,000 nm, such as less than about 999 nm, less than about 900 nm, less than about 800 nm, less than about 700 nm, less than about 600 nm, less than about 500 nm, less than about 400 nm, less than about 300 nm, or less than about 200 nm, and down to about 1 nm or less. In some instances, the term can refer to a particular sub-range within the general range, such as from about 1 nm to about 100 nm, from about 100 nm to about 200 nm, from about 200 nm to about 300 nm, from about 300 nm to about 400 nm, from about 400 nm to about 500 nm, from about 500 nm to about 600 nm, from about 600 nm to about 700 nm, from about 700 nm to about 800 nm, from about 800 nm to about 900 nm, or from about 900 nm to about 999 nm.

As used herein, the term “main group element” refers to a chemical element in any of Group IA (or Group 1), Group IIA (or Group 2), Group IIIA (or Group 13), Group IVA (or Group 14), Group VA (or Group 15), Group VIA (or Group 16), Group VIIA (or Group 17), and Group VIIIA (or Group 18). A main group element is also sometimes referred to as a s-block element or a p-block element.

As used herein, the term “transition metal” refers to a chemical element in any of Group IVB (or Group 4), Group VB (or Group 5), Group VIB (or Group 6), Group VIIB (or Group 7), Group VIIIB (or Groups 8, 9, and 10), Group IB (or Group 11), and Group IIB (or Group 12). A transition metal is also sometimes referred to as a d-block element.

As used herein, the term “rare earth element” refers to any of Sc, Y, La, Ce, Pr, Nd, Pm, Sm, Eu, Gd, Tb, Dy, Ho, Er, Tm, Yb, and Lu.

As used herein, the term “halogen” refers to any of F, Cl, Br, I, and At.

As used herein, the term “chalcogen” refers to any of O, S, Se, Te, and Po.

As used herein, the term “heteroatom” refers to any atom that is not a carbon atom or a hydrogen atom. Examples of heteroatoms include atoms of halogens, chalcogens, Group IIIA (or Group 13) elements, Group IVA (or Group 14) elements other than carbon, and Group VA (or Group 15) elements.

As used herein, the term “alkane” refers to a saturated hydrocarbon, including the more specific definitions of “alkane” herein. For certain embodiments, an alkane can include from 1 to 100 carbon atoms. The term “lower alkane” refers to an alkane that includes from 1 to 20 carbon atoms, such as from 1 to 10 carbon atoms, while the term “upper alkane” refers to an alkane that includes more than 20 carbon atoms, such as from 21 to 100 carbon atoms. The term “branched alkane” refers to an alkane that includes one or more branches, while the term “unbranched alkane” refers to an alkane that is straight-chained. The term “cycloalkane” refers to an alkane that includes one or more ring structures. The term “heteroalkane” refers to an alkane that has one or more of its carbon atoms replaced by one or more heteroatoms, such as N, Si, S, O, F, and P. The term “substituted alkane” refers to an alkane that has one or more of its hydrogen atoms replaced by one or more substituent groups, such as halo groups, while the term “unsubstituted alkane” refers to an alkane that lacks such substituent groups. Combinations of the above terms can be used to refer to an alkane having a combination of characteristics. For example, the term “branched lower alkane” can be used to refer to an alkane that includes from 1 to 20 carbon atoms and one or more branches. Examples of alkanes include methane, ethane, propane, cyclopropane, butane, 2-methylpropane, cyclobutane; and charged, hetero, or substituted forms thereof.

As used herein, the term “alkyl group” refers to a monovalent form of an alkane, including the more specific definitions of “alkyl” herein. For example, an alkyl group can be envisioned as an alkane with one of its hydrogen atoms removed to allow bonding to another group. The term “lower alkyl group” refers to a monovalent form of a lower alkane, while the term “upper alkyl group” refers to a monovalent form of an upper alkane. The term “branched alkyl group” refers to a monovalent form of a branched alkane, while the term “unbranched alkyl group” refers to a monovalent form of an unbranched alkane. The term “cycloalkyl group” refers to a monovalent form of a cycloalkane, and the term “heteroalkyl group” refers to a monovalent form of a heteroalkane. The term “substituted alkyl group” refers to a monovalent form of a substituted alkane, while the term “unsubstituted alkyl group” refers to a monovalent form of an unsubstituted alkane. Examples of alkyl groups include methyl, ethyl, n-propyl, isopropyl, cyclopropyl, butyl, isobutyl, t-butyl, cyclobutyl, and charged, hetero, or substituted forms thereof.

As used herein, the term “alkylene group” refers to a bivalent form of an alkane, including the more specific definitions of “alkylene group” herein. For example, an alkylene group can be envisioned as an alkane with two of its hydrogen atoms removed to allow bonding to one or more additional groups. The term “lower alkylene group” refers to a bivalent form of a lower alkane, while the term “upper alkylene group” refers to a bivalent form of an upper alkane. The term “branched alkylene group” refers to a bivalent form of a branched alkane, while the term “unbranched alkylene group” refers to a bivalent form of an unbranched alkane. The term “cycloalkylene group” refers to a bivalent form of a cycloalkane, and the term “heteroalkylene group” refers to a bivalent form of a heteroalkane. The term “substituted alkylene group” refers to a bivalent form of a substituted alkane, while the term “unsubstituted alkylene group” refers to a bivalent form of an unsubstituted alkane. Examples of alkylene groups include methylene, ethylene, propylene, 2-methylpropylene, and charged, hetero, or substituted forms thereof.

As used herein, the term “alkene” refers to an unsaturated hydrocarbon that includes one or more carbon-carbon double bonds, including the more specific definitions of “alkene” herein. For certain embodiments, an alkene can include from 2 to 100 carbon atoms. The term “lower alkene” refers to an alkene that includes from 2 to 20 carbon atoms, such as from 2 to 10 carbon atoms, while the term “upper alkene” refers to an alkene that includes more than 20 carbon atoms, such as from 21 to 100 carbon atoms. The term “cycloalkene” refers to an alkene that includes one or more ring structures. The term “heteroalkene” refers to an alkene that has one or more of its carbon atoms replaced by one or more heteroatoms, such as N, Si, S, O, F, and P. The term “substituted alkene” refers to an alkene that has one or more of its hydrogen atoms replaced by one or more substituent groups, such as halo groups, while the term “unsubstituted alkene” refers to an alkene that lacks such substituent groups. Combinations of the above terms can be used to refer to an alkene having a combination of characteristics. For example, the term “substituted lower alkene” can be used to refer to an alkene that includes from 1 to 20 carbon atoms and one or more substituent groups. Examples of alkenes include ethene, propene, cyclopropene, 1-butene, trans-2 butene, cis-2-butene, 1,3-butadiene, 2-methylpropene, cyclobutene, and charged, hetero, or substituted forms thereof.

As used herein, the term “alkenyl group” refers to a monovalent form of an alkene, including the more specific definitions of “alkenyl group” herein. For example, an alkenyl group can be envisioned as an alkene with one of its hydrogen atoms removed to allow bonding to another group. The term “lower alkenyl group” refers to a monovalent form of a lower alkene, while the term “upper alkenyl group” refers to a monovalent form of an upper alkene. The term “cycloalkenyl group” refers to a monovalent form of a cycloalkene, and the term “heteroalkenyl group” refers to a monovalent form of a heteroalkene. The term “substituted alkenyl group” refers to a monovalent form of a substituted alkene, while the term “unsubstituted alkenyl group” refers to a monovalent form of an unsubstituted alkene. Examples of alkenyl groups include ethenyl, 2-propenyl (i.e., allyl), isopropenyl, cyclopropenyl, butenyl, isobutenyl, t-butenyl, cyclobutenyl, and charged, hetero, or substituted forms thereof.

As used herein, the term “alkenylene group” refers to a bivalent form of an alkene, including the more specific definitions of “alkenylene group” herein. For example, an alkenylene group can be envisioned as an alkene with two of its hydrogen atoms removed to allow bonding to one or more additional groups. The term “lower alkenylene group” refers to a bivalent form of a lower alkene, while the term “upper alkenylene group” refers to a bivalent form of an upper alkene. The term “cycloalkenylene group” refers to a bivalent form of a cycloalkene, and the term “heteroalkenylene group” refers to a bivalent form of a heteroalkene. The term “substituted alkenylene group” refers to a bivalent form of a substituted alkene, while the term “unsubstituted alkenylene group” refers to a bivalent form of an unsubstituted alkene. Examples of alkenyl groups include ethenylene, propenylene, 2-methylpropenylene, and charged, hetero, or substituted forms thereof.

As used herein, the term “alkyne” refers to an unsaturated hydrocarbon that includes one or more carbon-carbon triple bonds, including the more specific definitions of “alkyne” herein. In some embodiments, an alkyne can also include one or more carbon-carbon double bonds. For certain embodiments, an alkyne can include from 2 to 100 carbon atoms. The term “lower alkyne” refers to an alkyne that includes from 2 to 20 carbon atoms, such as from 2 to 10 carbon atoms, while the term “upper alkyne” refers to an alkyne that includes more than 20 carbon atoms, such as from 21 to 100 carbon atoms. The term “cycloalkyne” refers to an alkyne that includes one or more ring structures. The term “heteroalkyne” refers to an alkyne that has one or more of its carbon atoms replaced by one or more heteroatoms, such as N, Si, S, O, F, and P. The term “substituted alkyne” refers to an alkyne that has one or more of its hydrogen atoms replaced by one or more substituent groups, such as halo groups, while the term “unsubstituted alkyne” refers to an alkyne that lacks such substituent groups. Combinations of the above terms can be used to refer to an alkyne having a combination of characteristics. For example, the term “substituted lower alkyne” can be used to refer to an alkyne that includes from 1 to 20 carbon atoms and one or more substituent groups. Examples of alkynes include ethyne (i.e., acetylene), propyne, 1-butyne, 1-buten-3-yne, 1-pentyne, 2-pentyne, 3-penten-1-yne, 1-penten-4-yne, 3-methyl-1-butyne, and charged, hetero, or substituted forms thereof.

As used herein, the term “alkynyl group” refers to a monovalent form of an alkyne, including the more specific definitions of “alkynyl group” herein. For example, an alkynyl group can be envisioned as an alkyne with one of its hydrogen atoms removed to allow bonding to another group. The term “lower alkynyl group” refers to a monovalent form of a lower alkyne, while the term “upper alkynyl group” refers to a monovalent form of an upper alkyne. The term “cycloalkynyl group” refers to a monovalent form of a cycloalkyne, and the term “heteroalkynyl group” refers to a monovalent form of a heteroalkyne. The term “substituted alkynyl group” refers to a monovalent form of a substituted alkyne, while the term “unsubstituted alkynyl group” refers to a monovalent form of an unsubstituted alkyne. Examples of alkynyl groups include ethynyl, propynyl, isopropynyl, butynyl, isobutynyl, t-butynyl, and charged, hetero, or substituted forms thereof.

As used herein, the term “alkynylene group” refers to a bivalent form of an alkyne, including the more specific definitions of “alkynylene group” herein. For example, an alkynylene group can be envisioned as an alkyne with two of its hydrogen atoms removed to allow bonding to one or more additional groups of a molecule. The term “lower alkynylene group” refers to a bivalent form of a lower alkyne, while the term “upper alkynylene group” refers to a bivalent form of an upper alkyne. The term “cycloalkynylene group” refers to a bivalent form of a cycloalkyne, and the term “heteroalkynylene group” refers to a bivalent form of a heteroalkyne. The term “substituted alkynylene group” refers to a bivalent form of a substituted alkyne, while the term “unsubstituted alkynylene group” refers to a bivalent form of an unsubstituted alkyne. Examples of alkynylene groups include ethynylene, propynylene, 1-butynylene, 1-buten-3-ynylene, and charged, hetero, or substituted forms thereof.

As used herein, the term “arene” refers to an aromatic hydrocarbon, including the more specific definitions of “arene” herein. For certain embodiments, an arene can include from 5 to 100 carbon atoms. The term “lower arene” refers to an arene that includes from 5 to 20 carbon atoms, such as from 5 to 14 carbon atoms, while the term “upper arene” refers to an arene that includes more than 20 carbon atoms, such as from 21 to 100 carbon atoms. The term “monocyclic arene” refers to an arene that includes a single aromatic ring structure, while the term “polycyclic arene” refers to an arene that includes more than one aromatic ring structure, such as two or more aromatic ring structures that are bonded via a carbon-carbon bond or that are fused together. The term “heteroarene” refers to an arene that has one or more of its carbon atoms replaced by one or more heteroatoms, such as N, Si, S, O, F, and P. The term “substituted arene” refers to an arene that has one or more of its hydrogen atoms replaced by one or more substituent groups, such as alkyl groups, alkenyl groups, alkynyl groups, halo groups, hydroxy groups, alkoxy groups, alkenoxy groups, alkynoxy groups, aryloxy groups, carboxy groups, cyano groups, nitro groups, amino groups, N-substituted amino, groups, silyl groups, and siloxy groups, while the term “unsubstituted arene” refers to an arene that lacks such substituent groups. Combinations of the above terms can be used to refer to an arene having a combination of characteristics. For example, the term “monocyclic lower alkene” can be used to refer to an arene that includes from 5 to 20 carbon atoms and a single aromatic ring structure. Examples of arenes include benzene, biphenyl, naphthalene, anthracene, pyridine, pyridazine, pyrimidine, pyrazine, quinoline, isoquinoline, and charged, hetero, or substituted forms thereof.

As used herein, the term “aryl group” refers to a monovalent form of an arene, including the more specific definitions of “aryl group” herein. For example, an aryl group can be envisioned as an arene with one of its hydrogen atoms removed to allow bonding to another group. The term “lower aryl group” refers to a monovalent form of a lower arene, while the term “upper aryl group” refers to a monovalent form of an upper arene. The term “monocyclic aryl group” refers to a monovalent form of a monocyclic arene, while the term “polycyclic aryl group” refers to a monovalent form of a polycyclic arene. The term “heteroaryl group” refers to a monovalent form of a heteroarene. The term “substituted aryl group” refers to a monovalent form of a substituted arene, while the term “unsubstituted arene group” refers to a monovalent form of an unsubstituted arene. Examples of aryl groups include phenyl, biphenylyl, naphthyl, pyridinyl, pyridazinyl, pyrimidinyl, pyrazinyl, quinolyl, isoquinolyl, and charged, hetero, or substituted forms thereof.

As used herein, the term “imine” refers to an organic compound that includes one or more carbon-nitrogen double bonds, including the more specific definitions of “imine” herein. For certain embodiments, an imine can include from 1 to 100 carbon atoms. The term “lower imine” refers to an imine that includes from 1 to 20 carbon atoms, such as from 1 to 10 carbon atoms, while the term “upper imine” refers to an imine that includes more than 20 carbon atoms, such as from 21 to 100 carbon atoms. The term “cycloimine” refers to an imine that includes one or more ring structures. The term “heteroimine” refers to an imine that has one or more of its carbon atoms replaced by one or more heteroatoms, such as N, Si, S, O, F, and P. The term “substituted imine” refers to an imine that has one or more of its hydrogen atoms replaced by one or more substituent groups, such as halo groups, while the term “unsubstituted imine” refers to an imine that lacks such substituent groups. Combinations of the above terms can be used to refer to an imine having a combination of characteristics. For example, the term “substituted lower imine” can be used to refer to an imine that includes from 1 to 20 carbon atoms and one or more substituent groups. Examples of imines include R₁CH═NR₂, where R₁ and R₂ are independently selected from hydride groups, alkyl groups, alkenyl groups, and alkynyl groups.

As used herein, the term “iminyl group” refers to a monovalent form of an imine, including the more specific definitions of “iminyl” herein. For example, an iminyl group can be envisioned as an imine with one of its hydrogen atoms removed to allow bonding to another group. The term “lower iminyl group” refers to a monovalent form of a lower imine, while the term “upper iminyl group” refers to a monovalent form of an upper imine. The term “cycloiminyl group” refers to a monovalent form of a cycloimine, and the term “heteroiminyl group” refers to a monovalent form of a heteroimine. The term “substituted iminyl group” refers to a monovalent form of a substituted imine, while the term “unsubstituted iminyl group” refers to a monovalent form of an unsubstituted imine. Examples of iminyl groups include —R₁CH═NR₂, R₃CH═NR₄—, —CH═NR₅, and R₆CH═N—, where R₁ and R₄ are independently selected from alkylene groups, alkenylene groups, and alkynylene groups, and R₂, R₃, R₅, and R₆ are independently selected from hydride groups, alkyl groups, alkenyl groups, and alkynyl groups.

As used herein, the term “alcohol” refers to an organic compound that includes one or more hydroxy groups. For certain embodiments, an alcohol can also be referred to as a substituted hydrocarbon, such as a substituted arene that has one or more of its hydrogen atoms replaced by one or more hydroxy groups. Examples of alcohols include ROH, where R is selected from alkyl groups, alkenyl groups, alkynyl groups, and aryl groups.

As used herein, the term “ketone” refers to a molecule that includes one or more groups of the form: —CO—. Examples of ketones include R₁—CO—R₂, where R₁ and R₂ are independently selected from alkyl groups, alkenyl groups, alkynyl groups, and aryl groups, and R₃—CO—R₄—CO—R₅, where R₃ and R₅ are independently selected from alkyl groups, alkenyl groups, alkynyl groups, and aryl groups, and R₄ is selected from alkylene groups, alkenylene groups, and alkynylene groups.

As used herein, the term “carboxylic acid” refers to an organic compound that includes one or more carboxy groups. For certain embodiments, a carboxylic acid can also be referred to as a substituted hydrocarbon, such as a substituted arene that has one or more of its hydrogen atoms replaced by one or more carboxy groups. Examples of carboxylic acids include RCOOH, where R is selected from alkyl groups, alkenyl groups, alkynyl groups, and aryl groups.

As used herein, the term “hydride group” refers to —H.

As used herein, the term “halo group” refers to —X, where X is a halogen. Examples of halo groups include fluoro, chloro, bromo, and iodo.

As used herein, the term “hydroxy group” refers to —OH.

As used herein, the term “alkoxy group” refers to —OR, where R is an alkyl group.

As used herein, the term “alkenoxy group” refers to —OR, where R is an alkenyl group.

As used herein, the term “alkynoxy group” refers to —OR, where R is an alkynyl group.

As used herein, the term “aryloxy group” refers to —OR, where R is an aryl group.

As used herein, the term “carboxy group” refers to —COOH.

As used herein, the term “alkylcarbonyloxy group” refers to RCOO—, where R is an alkyl group.

As used herein, the term “alkenylcarbonyloxy group” refers to RCOO—, where R is an alkenyl group.

As used herein, the term “alkynylcarbonyloxy group” refers to RCOO—, where R is an alkynyl group.

As used herein, the term “arylcarbonyloxy group” refers to RCOO—, where R is an aryl group.

As used herein, the term “thio group” refers to —SH.

As used herein, the term “alkylthio group” refers to —SR, where R is an alkyl group.

As used herein, the term “alkenylthio group” refers to —SR, where R is an alkenyl group.

As used herein, the term “alkynylthio group” refers to —SR, where R is an alkynyl group.

As used herein, the term “arylthio group” refers to —SR, where R is an aryl group.

As used herein, the term “cyano group” refers to —CN.

As used herein, the term “nitro group” refers to —NO₂.

As used herein, the term “amino group” refers to —NH₂.

As used herein, the term “N-substituted amino group” refers to an amino group that has one or more of its hydrogen atoms replaced by one or more substituent groups. Examples of N-substituted amino groups include —NR₁R₂, where R₁ and R₂ are independently selected from hydride groups, alkyl groups, alkenyl groups, alkynyl groups, and aryl groups, and at least one of R₁ and R₂ is not a hydride group.

As used herein, the term “alkylcarbonylamino group” refers to —NHCOR, where R is an alkyl group.

As used herein, the term “N-substituted alkylcarbonylamino group” refers to an alkylcarbonylamino group that has its hydrogen atom replaced by a substituent group. Examples of N-substituted alkylcarbonylamino groups include —NR₁COR₂, where R₁ is selected from alkyl groups, alkenyl groups, alkynyl groups, and aryl groups, and R₂ is an alkyl group.

As used herein, the term “alkenylcarbonylamino group” refers to —NHCOR, where R is an alkenyl group.

As used herein, the term “N-substituted alkenylcarbonylamino group” refers to an alkenylcarbonylamino group that has its hydrogen atom replaced by a substituent group. Examples of N-substituted alkenylcarbonylamino groups include —NR₁COR₂, where R₁ is selected from alkyl groups, alkenyl groups, alkynyl groups, and aryl groups, and R₂ is an alkenyl group.

As used herein, the term “alkynylcarbonylamino group” refers to —NHCOR, where R is an alkynyl group.

As used herein, the term “N-substituted alkynylcarbonylamino group” refers to an alkynylcarbonylamino group that has its hydrogen atom replaced by a substituent group. Examples of N-substituted alkynylcarbonylamino groups include —NR₁COR₂, where R₁ is selected from alkyl groups, alkenyl groups, alkynyl groups, and aryl groups, and R₂ is an alkynyl group.

As used herein, the term “arylcarbonylamino group” refers to NHCOR, where R is an aryl group.

As used herein, the term “N-substituted arylcarbonylamino group” refers to an arylcarbonylamino group that has its hydrogen atom replaced by a substituent group. Examples of N-substituted arylcarbonylamino groups include —NR₁COR₂, where R₁ is selected from alkyl groups, alkenyl groups, alkynyl groups, and aryl groups, and R₂ is an aryl group.

As used herein, the term “silyl group” refers to —SiR₁R₂R₃, where R₁, R₂, and

R₃ are independently selected from, for example, hydride groups, alkyl groups, alkenyl groups, alkynyl groups, and aryl groups.

As used herein, the term “siloxy group” refers to —OSiR₁R₂R₃, where R₁, R₂, and R₃ are independently selected from, for example, hydride groups, alkyl groups, alkenyl groups, alkynyl groups, and aryl groups.

As used herein, the term “ether linkage” refers to —O—.

As used herein, the term “specific capacity” refers to the amount (e.g., total or maximum amount) of electrons or lithium ions a material is able to hold (or discharge) per unit mass and can be expressed in units of mAh/g. In certain aspects and embodiments, specific capacity can be measured in a constant current discharge (or charge) analysis which includes discharge (or charge) at a defined rate over a defined voltage range against a defined counterelectrode. For example, specific capacity can be measured upon discharge at a rate of about 0.05C (e.g., about 7.5 mA/g) from 4.95 V to 2.0 V versus a Li/Li⁺ counterelectrode. Other discharge rates and other voltage ranges also can be used, such as a rate of about 0.1C (e.g., about 15 mA/g), or about 0.5C (e.g., about 75 mA/g), or about 1.0C (e.g., about 150 mA/g).

As used herein, a rate “C” refers to either (depending on context) the discharge current as a fraction or multiple relative to a “1C” current value under which a battery (in a substantially fully charged state) would substantially fully discharge in one hour, or the charge current as a fraction or multiple relative to a “1C” current value under which the battery (in a substantially fully discharged state) would substantially fully charge in one hour.

As used herein, the terms “cycle” or “cycling” refer to complementary discharging and charging processes.

As used herein, the term “rated charge voltage” refers to an upper end of a voltage range during operation of a battery, such as a maximum voltage during charging, discharging, and/or cycling of the battery. In some aspects and some embodiments, a rated charge voltage refers to a maximum voltage upon charging a battery from a substantially fully discharged state through its (maximum) specific capacity at an initial cycle, such as the 1^{st} cycle, the 2^{nd} cycle, or the 3^{rd} cycle. In some aspects and some embodiments, a rated charge voltage refers to a maximum voltage during operation of a battery to substantially maintain one or more of its performance characters, such as one or more of coulombic efficiency, retention of specific capacity, retention of energy density, and rate capability.

As used herein, the term “rated cut-off voltage” refers to a lower end of a voltage range during operation of a battery, such as a minimum voltage during charging, discharging, and/or cycling of the battery. In some aspects and some embodiments, a rated cut-off voltage refers to a minimum voltage upon discharging a battery from a substantially fully charged state through its (maximum) specific capacity at an initial cycle, such as the 1^{st} cycle, the 2^{nd} cycle, or the 3^{rd} cycle, and, in such aspects and embodiments, a rated cut-off voltage also can be referred as a rated discharge voltage. In some aspects and some embodiments, a rated cut-off voltage refers to a minimum voltage during operation of a battery to substantially maintain one or more of its performance characters, such as one or more of coulombic efficiency, retention of specific capacity, retention of energy density, and rate capability.

As used herein, the “maximum voltage” refers to the voltage at which both the anode and the cathode are fully charged. In an electrochemical cell, each electrode may have a given specific capacity and one of the electrodes will be the limiting electrode such that one electrode will be fully charged and the other will be as fully charged as it can be for that specific pairing of electrodes. The process of matching the specific capacities of the electrodes to achieve the desired capacity of the electrochemical cell is “capacity matching.”

To the extent certain battery characteristics can vary with temperature, such characteristics are specified at room temperature (25° C.), unless the context clearly dictates otherwise.

Certain embodiments of the invention relate to electrolyte solutions that provide a number of desirable characteristics when implemented within batteries, such as high stability during battery cycling to high voltages at or above 4.2 V, high specific capacity upon charge or discharge, high coulombic efficiency, excellent retention of specific capacity and energy density over several cycles of charging and discharging, high rate capability, reduced electrolyte decomposition, reduced resistance and its build-up during cycling, and improved calendar life. The electrolyte solutions provide these performance characteristics over a wide range of operational temperatures, encompassing about −40° C. or less and up to about 60° C., up to about 80° C., or more. In some embodiments, these performance characteristics can at least partially derive from the presence of a set of additives or compounds, which can impart high voltage and high temperature stability to an electrolyte while retaining or improving battery performance.

For example, in terms of their stability, electrolytes that include compounds according to some embodiments of the invention can undergo little or no decomposition (beyond any initial decomposition related to film formation at battery electrodes or as part of initial cycling) when batteries incorporating the electrolytes are cycled at least up to a redox potential of a high voltage cathode material, such as at least about 4.2 V or about 4.5 V and up to about 4.95 V, up to about 5 V, up to about 5.5 V, up to about 6 V or more, as measured relative to a lithium metal anode (Li/Li⁺ anode). These voltages may vary for other counterelectrodes, but the improved performance is retained according to some embodiments. Such reduction in electrolyte decomposition, in turn, yields one or more of the following benefits: (1) mitigation against loss of electrolyte; (2) mitigation against the production of undesirable by-products that can affect battery performance; (3) mitigation against the production of gaseous by-products that can affect battery safety; and (4) reduced resistance and its build-up during cycling.

Also, batteries incorporating the electrolyte solutions including compounds according to certain embodiments can exhibit high coulombic efficiency, as expressed in terms of a ratio of a specific capacity upon discharge to a specific capacity upon charge for a given cycle. As measured upon cycling at a rate of 1C (or another reference rate higher or lower than 1C, such as 0.1C, 0.05C, 0.5C, 5C, or 10C), batteries incorporating the improved electrolytes can have a coulombic efficiency at the 1st cycle (or another initial cycle, such as the 2^{nd} cycle, the 3^{rd} cycle, the 4^{th} cycle, the 5^{th} cycle, the 6^{th} cycle, the 7^{th} cycle, the 8^{th} cycle, the 9^{th} cycle, or the 10^{th} cycle) or an average coulombic efficiency over an initial set of cycles, such as cycles 1 through 3, cycles 1 through 5, cycles 3 through 10, cycles 5 through 10, or cycles 5 through 15, that is at least about 60%, such as at least about 70%, at least about 80%, at least about 90%, or at least about 95%, and up to about 97%, up to about 98%, up to about 99%, up to about 99.8%, up to about 99.9%, up to about 99.99%, up to about 99.999%, or more. Stated in another way, and as measured upon cycling at a substantially constant current of 150 mA/g (or another reference current higher or lower than 150 mA/g, such as 15 mA/g, 7.5 mA/g, 75 mA/g, 750 mA/g, or 1,500 mA/g), batteries incorporating the electrolyte solutions including compounds of certain embodiments can have a coulombic efficiency at the 1^{st} cycle (or another initial cycle, such as the 2^{nd} cycle, the 3^{rd} cycle, the 4^{th} cycle, the 5^{th} cycle, the 6^{th} cycle, the 7^{th} cycle, the 8^{th} cycle, the 9^{th} cycle, or the 10^{th} cycle) or an average coulombic efficiency over an initial set of cycles, such as cycles 1 through 3, cycles 1 through 5, cycles 3 through 10, cycles 5 through 10, or cycles 5 through 15, that is at least about 60%, such as at least about 70%, at least about 80%, at least about 90%, or at least about 95%, and up to about 97%, up to about 98%, up to about 99%, up to about 99.8%, up to about 99.9%, up to about 99.99%, up to about 99.999%, or more. The stated values for current can be per unit mass of a cathode active material, and can be expressed in units of mA/(g of the cathode active material).

In addition, batteries incorporating the electrolyte solutions including compounds of certain embodiments can exhibit excellent capacity retention defined in terms of a specific capacity (both upon charge and upon discharge) over several charging and discharging cycles, such that, after 100 cycles, after 200 cycles, after 300 cycles, after 400 cycles, after 500 cycles, after 600 cycles, after 1,000 cycles, or even after 5,000 cycles from an initial cycle, at least about 50%, at least about 60%, at least about 70%, at least about 75%, at least about 80%, or at least about 85%, and up to about 90%, up to about 95%, up to about 98%, or more of an initial or maximum specific capacity at the 1st cycle (or another initial cycle, such as the 2^{nd} cycle, the 3^{rd} cycle, the 4^{th} cycle, the 5^{th} cycle, the 6^{th} cycle, the 7^{th} cycle, the 8^{th} cycle, the 9^{th} cycle, or the 10^{th} cycle) is retained, as measured upon cycling at a rate of 1C (or another reference rate higher or lower than 1C, such as 0.1C, 0.05C, 0.5C, 5C, or 10C) or upon cycling at a substantially constant current of 150 mA/g (or another reference current higher or lower than 150 mA/g, such as 15 mA/g, 7.5 mA/g, 75 mA/g, 750 mA/g, or 1,500 mA/g). The stated values for current can be per unit mass of a cathode active material, and can be expressed in units of mA/(g of the cathode active material).

In addition, batteries incorporating the electrolyte solutions including compounds of certain embodiments can exhibit excellent efficiency retention defined in terms of a coulombic efficiency over several charging and discharging cycles, such that, after 100 cycles, after 200 cycles, after 300 cycles, after 400 cycles, after 500 cycles, after 600 cycles, after 1,000 cycles, or even after 5,000 cycles from an initial cycle, at least about 70%, at least about 80%, at least about 90%, or at least about 95%, and up to about 97%, up to about 98%, up to about 99%, up to about 99.9%, or more of an initial or maximum coulombic efficiency at the 1^{st} cycle (or another initial cycle, such as the 2^{nd} cycle, the 3^{rd} cycle, the 4^{th} cycle, the 5^{th} cycle, the 6^{th} cycle, the 7^{th} cycle, the 8^{th} cycle, the 9^{th} cycle, or the 10^{th} cycle) is retained, as measured upon cycling at a rate of 1C (or another reference rate higher or lower than 1C, such as 0.1C, 0.05C, 0.5C, 5C, or 10C) or upon cycling at a substantially constant current of 150 mA/g (or another reference current higher or lower than 150 mA/g, such as 15 mA/g, 7.5 mA/g, 75 mA/g, 750 mA/g, or 1,500 mA/g). The stated values for current can be per unit mass of a cathode active material, and can be expressed in units of mA/(g of the cathode active material).

In terms of rate capability or power performance, batteries incorporating the electrolyte solutions including compounds of certain embodiments can exhibit excellent rate capability defined in terms of retention of specific capacity (both upon charge and upon discharge) when charged, discharged, or cycled at higher rates, such that, as measured at a high rate of 1C (or another high rate that is n times a reference, low rate, with n>1 such as n=5, n=10, n=20, or n=100), at least about 60%, at least about 70%, at least about 75%, at least about 80%, at least about 85%, at least about 90%, or at least about 95%, and up to about 99%, up to about 99.5%, up to about 99.9%, or more of a low rate or maximum specific capacity at a rate of 0.05C (or another reference rate higher or lower than 0.05C, such as 0.1C) is retained. Stated in another way, batteries incorporating the electrolyte solutions including compounds of certain embodiments can exhibit excellent retention of specific capacity (both upon charge and upon discharge) when charged, discharged, or cycled at higher currents, such that, as measured at a substantially constant current of 150 mA/g (or another current that is n times a reference current, with n>1 such as n=5, n=10, n=20, or n=100), at least about 60%, at least about 70%, at least about 75%, at least about 80%, at least about 85%, at least about 90%, or at least about 95%, and up to about 99%, up to about 99.5%, up to about 99.9%, or more of a low rate or maximum specific capacity at a substantially constant current of 7.5 mA/g (or another reference current higher or lower than 7.5 mA/g, such as 15 mA/g) is retained. The stated values for current can be per unit mass of a cathode active material, and can be expressed in units of mA/(g of the cathode active material).

Likewise, batteries incorporating the electrolyte solutions including compounds of certain embodiments can exhibit excellent rate capability defined in terms of retention of energy density when cycled at higher rates, such that, as measured at a rate of 1C (or another rate that is n times a reference rate, with n>1 such as n=5, n=10, n=20, or n=100), at least about 60%, at least about 70%, at least about 75%, at least about 80%, at least about 85%, at least about 90%, or at least about 95%, and up to about 99%, up to about 99.5%, up to about 99.9%, or more of a low rate or maximum coulombic efficiency at a rate of 0.05C (or another reference rate higher or lower than 0.05C, such as 0.1C) is retained. Stated in another way, batteries incorporating the electrolyte solutions including compounds of certain embodiments can exhibit excellent retention of energy density when cycled at higher currents, such that, as measured at a substantially constant current of 150 mA/g (or another current that is n times a reference current, with n>1 such as n=5, n=10, n=20, or n=100), at least about 60%, at least about 70%, at least about 75%, at least about 80%, at least about 85%, at least about 90%, or at least about 95%, and up to about 99%, up to about 99.5%, up to about 99.9%, or more of a low rate or maximum coulombic efficiency at a substantially constant current of 7.5 mA/g (or another reference current higher or lower than 7.5 mA/g, such as 15 mA/g) is retained. The stated values for current can be per unit mass of a cathode active material, and can be expressed in units of mA/(g of the cathode active material).

In addition, batteries incorporating the electrolyte solutions including compounds of certain embodiments can have a reduced resistance and a reduced resistance build-up during cycling. Such reduced resistance, in turn, yields one or more of the following benefits: (1) efficient removal of Li ions from electrodes; (2) higher specific capacity and higher energy density; (3) reduced hysteresis in a voltage profile between charging and discharging; and (4) mitigation against temperature increase during cycling.

Advantageously, the electrolyte solutions including compounds of certain embodiments can provide these performance characteristics over a wide range of operational temperatures, such as when batteries incorporating the electrolyte solutions including compounds of certain embodiments are charged, discharged, or cycled from about −40° C. to about 80° C., from about −40° C. to about 60° C., from about −40° C. to about 25° C., from about −40° C. to about 0° C., from about 0° C. to about 60° C., from about 0° C. to about 25° C., from about 25° C. to about 60° C., or other ranges encompassing temperatures greater than or below 25° C. The improved electrolytes also can provide these performance characteristics over a wide range of operational voltages between a rated cut-off voltage and a rated charge voltage, such as when the batteries are charged, discharged, or cycled between voltage ranges encompassing about 2 V to about 4.2 V, about 2 V to about 4.3 V, about 2 V to about 4.5 V, about 2 V to about 4.6 V, about 2 V to about 4.7 V, about 2 V to about 4.95 V, about 3 V to about 4.2 V, about 3 V to about 4.3 V, about 3 V to about 4.5 V, about 3 V to about 4.6 V, about 3 V to about 4.7 V, about 3 V to about 4.9 V, about 2 V to about 6 V, about 3 V to about 6 V, about 4.2 V to about 6 V, about 4.5 V to about 6 V, about 2 V to about 5.5 V, about 3 V to about 5.5 V, about 4.5 V to about 5.5 V, about 2 V to about 5 V, about 3 V to about 5 V, about 4.5 V to about 5 V, or about 5 V to about 6 V, as measured relative to a lithium metal anode (Li/Li⁺ anode). Stated in another way, the batteries incorporating the electrolyte solutions including compounds of certain embodiments have a rated charge voltage of at least about 4.2 V, at least about 4.3 V, at least about 4.5 V, at least about 4.6 V, at least about 4.7 V, or at least about 5 V, and up to about 5.5 V, up to about 6 V or more, as measured relative to anodes included within the batteries and upon charging at a rate of 1C (or another reference rate higher or lower than 1C, such as 0.1C, 0.05C, 0.5C, 5C, or 10C) or upon charging at a substantially constant current of 150 mA/g (or another reference current higher or lower than 150 mA/g, such as 15 mA/g, 7.5 mA/g, 75 mA/g, 750 mA/g, or 1,500 mA/g). The batteries can be charged to the rated charge voltage while substantially retaining the performance characteristics specified above, such as in terms of coulombic efficiency, retention of specific capacity, retention of coulombic efficiency, and rate capability.

A high voltage electrolyte according to some embodiments of the invention can be formed with reference to the formula:

base electrolyte+stabilizing compound(s)→high voltage electrolyte (1)

A high temperature electrolyte according to some embodiments of the invention can be formed with reference to the formula:

base electrolyte+stabilizing compound(s)→high temperature electrolyte (2)

In formulas (1) and (2), the base electrolyte can include a set of solvents and a set of salts, such as a set of Li-containing salts in the case of Li-ion batteries. Examples of suitable solvents include nonaqueous electrolyte solvents for use in Li-ion batteries, including carbonates, such as ethylene carbonate, dimethyl carbonate, ethyl methyl carbonate, propylene carbonate, methyl propyl carbonate, and diethyl carbonate; sulfones; silanes; nitriles; esters; ethers; and combinations thereof. Additional examples of suitable solvents include those discussed in Xu et al., “Sulfone-based Electrolytes for Lithium-Ion Batteries,” Journal of the Electrochemical Society, 149 (7) A920-A926 (2002); and Nagahama et al., “High Voltage Performances of Li₂NiPO₄F Cathode with Dinitrile-Based Electrolytes,” Journal of the Electrochemical Society, 157 (6) A748-A752 (2010); the disclosures of which are incorporated herein by reference in their entirety. Examples of suitable salts include Li-containing salts for use in Li-ion batteries, such as lithium hexafluorophosphate (“LiPF₆”), lithium perchlorate (“LiClO₄”), lithium tetrafluoroborate (“LiBF₄”), lithium trifluoromethane sulfonate (“LiCF₃SO₃”), lithium bis(trifluoromethane sulfonyl)imide (“LiN(CF₃ SO₂)₂”), lithium bis(perfluoroethyl sulfonyl)imide (“LiN(CF₃CF₂ SO₂)₂”), lithium bis(oxalato)borate (“LiB(C₂O₄)₂”), lithium difluoro oxalato borate (“LiF₂BC₂O₄”), and combinations thereof. Other suitable solvents and salts can be used to yield high voltage and high temperature electrolytes having low electronic conductivity, high Li ion solubility, low viscosity, high thermal stability, and other desirable characteristics.

In formulas (1) and (2), the stabilizing compound(s) is a set of additives that can correspond to a single additive, a pair of different additives, or a combination of three or more different additives. Examples of suitable stabilizing additives include (i) boron-containing compounds, such as boronic esters (or boronates), boranes, borates, and other compounds including a B₂O₄ moiety, a BX₃ moiety, or a BX₄ moiety; (ii) carbonates; (iii) esters; (iv) monomers or other compounds capable of undergoing polymerization; (v) nitrogen-containing compounds, such as nitriles, nitrogen-containing heteroaromatic groups, and nitro compounds; (vi) phosphorus-containing compounds, such as phosphoranes, phosphoniums, phosphates, phosphines, phosphites, and other compounds including a PX₃ moiety or a PX₅ moiety; (vii) sulfur-containing compounds, such as sulfones, sulfoxides, sulfides, thiols, sulfonic esters (or sulfonates), and other compounds including a SO₂ moiety or a SO moiety; (viii) salts, such as salts of main group elements, salts of rare earth elements, and salts of transition metals; and (ix) anhydrides. One or more of the stabilizing additives described herein can be used in combination with one or more conventional additives to impart improved performance characteristics.

Examples of suitable boron-containing compounds include boranes represented with reference to the formula:

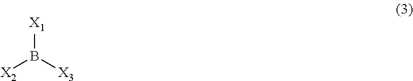

In formula (3), X₁, X₂, and X₃ can be the same or different, and, in some embodiments, at least one of X₁, X₂, and X₃ is an organic group including from 1 to 20 carbon atoms. For other embodiments, at least one of X₁, X₂, and X₃ is an organic group including more than 20 carbon atoms. X₁, X₂, and X₃ can be independently selected from, for example, hydride group, halo groups, hydroxy group, thio group, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenyl carbonylamino groups, alkynylcarbonylamino groups, N-substituted alkynylcarbonylamino groups, arylcarbonylamino groups, N-substituted arylcarbonylamino groups, silyl groups, siloxy groups, and fluorinated groups.

In some embodiments, at least one of X₁, X₂, and X₃ in formula (3) is a N-substituted amino group. A particular example of such a borane according to formula (3) is a boron-nitrogen-containing compound, namely Tris(dimethylamido)borane represented with reference to the formula:

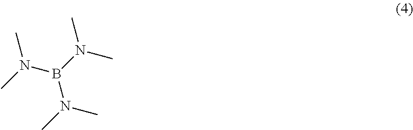

In formula (4), it is contemplated that one or more of the methyl or methyl-amino groups can be modified, such as by substituting a constituent hydrogen or carbon atom with another chemical element or functional group, or can be replaced by another alkyl group, an alkenyl group, an alkynyl group, or an aryl group, either in a substituted or an unsubstituted form. Other functionalizations or modifications of the borane set forth in formula (4) are contemplated.

In some embodiments, at least one of X₁, X₂, and X₃ in formula (3) is selected from alkoxy groups, alkenoxy groups, alkynoxy groups, and aryloxy groups. A particular example of such a borane according to formula (3) is a BO₃-containing compound, namely Trimethoxy borane represented with reference to the formula:

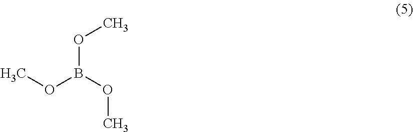

In formula (5), it is contemplated that one or more of the O—CH₃ groups can be modified, such as by substituting a constituent hydrogen or carbon atom with another chemical element or functional group, or can be replaced by another alkyl group, an alkenyl group, an alkynyl group, or an aryl group, either in a substituted or an unsubstituted form. Other functionalizations or modifications of the additive set forth in formula (5) are contemplated.

Additional examples of suitable boron-containing compounds include borates represented with reference to the formula:

L+[BX₁X₂X₃X₄]⁻ (6)

In formula (6), L⁺ is a cation or other positively charged moiety, and, in some embodiments, L⁺ includes from 1 to 20 carbon atoms. For other embodiments, L⁺ includes more than 20 carbon atoms. X₁, X₂, X₃, and X₄ can be the same or different, and can be independently selected from, for example, hydride groups, halo groups, and hydroxy groups. In some embodiments, at least one of X₁, X₂, X₃, and X₄ is a halo group, and L⁺ is represented as [PHR₁R₂R₃]⁺, where R₁, R₂, and R₃ can be independently selected from, for example, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups.

A particular example of a borate according to formula (6) is a boron-phosphine-containing salt, namely Tri-t-butylphosphonium tetrafluoroborate represented with reference to the formula:

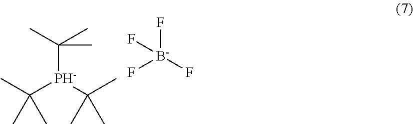

In formula (7), it is contemplated that one or more of the alkyl groups can be modified, such as by substituting a constituent hydrogen or carbon atom with another chemical element or functional group, or can be replaced by another alkyl group, an alkenyl group, an alkynyl group, or an aryl group, either in a substituted or an unsubstituted form. For example, one of the t-butyl groups can be replaced by a methyl group to yield di-t-butylmethylphosphonium tetrafluoroborate. Other functionalizations or modifications of the borate set forth in formula (7) are contemplated.

Examples of suitable boron-containing compounds include, but are not limited to: Bis(hexyleneglycolato)diboron, Bis(pinacolato)diboron, Borane-pyridine complex, Boron fluoride ethyl ether complex (47-48% Boron fluoride), Boron oxide, Lithium bis(oxalato)borate, Trimethyl borate, Tris(hexafluoroisopropyl borate, Boron phosphate, and combinations thereof.

Examples of suitable carbonates include acyclic and cyclic carbonates represented with reference to the formulas:

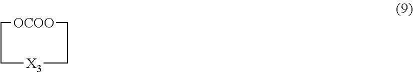

In formula (8), X₁ and X₂ can be the same or different, and, in some embodiments, at least one of X₁ and X₂ is an organic group including from 1 to 20 carbon atoms. For other embodiments, at least one of X₁ and X₂ is an organic group including more than 20 carbon atoms. X₁ and X₂ can be independently selected from, for example, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups. In formula (9), X₃ is a bivalent, organic group including from 1 to 20 carbon atoms in some embodiments, and, for other embodiments, X₃ is a bivalent, organic group including more than 20 carbon atoms. X₃ can be selected from, for example, alkylene groups, alkenylene groups, and alkynylene groups. Examples of suitable carbonates include, but are not limited to: Ethylene carbonate, Dimethyl carbonate, Ethyl methyl carbonate, Propylene carbonate, Methyl propyl carbonate, Diethyl carbonate, Diallyl carbonate, Vinylene carbonate, Ethylene thiocarbonate, Lithium Carbonate, and combinations thereof.

Examples of suitable esters include those represented with reference to the formula:

X₁—COO—X₂ (10)

In formula (10), X₁ and X₂ can be the same or different, and, in some embodiments, at least one of X₁ and X₂ is an organic group including from 1 to 20 carbon atoms. For other embodiments, at least one of X₁ and X₂ is an organic group including more than 20 carbon atoms. X₁ and X₂ can be independently selected from, for example, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups and fluorinated groups. Particular examples of esters according to formula (10) include, but are not limited to: Diethyl phthalate, Ethyl acetate, Ethyl benzoate, Ethyl isobutyrylacetate, Methyl benzoate, Methyl methacrylate, 1,1,1,3,3,3-Hexafluoroisopropyl acrylate, 2,2,2-Trifluoroethyl methacrylate and combinations thereof.

Examples of suitable monomers include alkenes, alkynes, arenes, and imines. Particular examples of suitable monomers include heterocycloalkenes and monocyclic and polycyclic heteroarenes, such as Furan represented with reference to the formula:

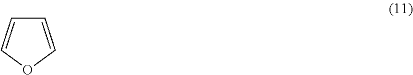

In formula (II), it is contemplated that one or more of the hydrogen atoms can be modified, such as by substituting with another chemical element or functional group, or can be replaced by an alkyl group, an alkenyl group, an alkynyl group, or an aryl group, either in a substituted or an unsubstituted form. Other functionalizations or modifications are contemplated, including increasing or decreasing the number of carbon atoms in the ring structure set forth in formula (II). Other examples of suitable monomers include, but are not limited to: Pyridine, Pyrimidine, Tetrahydropyran, 3-Bromothiophene, 3-Chlorothiophene, 3-Iodothiophene, 3-Methylpyrrole, 3-Methylthiophene, piperazine, Thiophene, Pyrrole, 2-Vinylpyridine, and combinations thereof.

Examples of suitable nitrogen-containing compounds include nitriles represented with reference to the formulas:

X₁—CN (12)

NC—X₂—CN (13)

In formula (12), X₁ is an organic group including from 1 to 20 carbon atoms in some embodiments, and, for other embodiments, X₁ is an organic group including more than carbon atoms. X₁ can be selected from, for example, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups. In formula (13), X₂ is a bivalent, organic group including from 1 to 20 carbon atoms in some embodiments, and, for other embodiments, X₂ is a bivalent, organic group including more than 20 carbon atoms. X₃ can be selected from, for example, alkylene groups, alkenylene groups, and alkynylene groups.

A particular example of a nitrile according to formula (13) is Suberonitrile represented with reference to the formula:

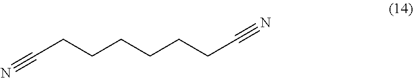

In formula (14), it is contemplated that one or more of the carbon or hydrogen atoms can be modified, such as by substituting with another chemical element or functional group, or can be replaced by an alkyl group, an alkenyl group, an alkynyl group, or an aryl group, either in a substituted or an unsubstituted form. Other functionalizations or modifications of the nitrile set forth in formula (14) are contemplated. Other examples of nitrogen-containing compounds include, but are not limited to: Sebaconitrile, Glutaronitrile (Pentanedinitrile), 1,4-Dicyanobutane (Adiponitrile), Succinimide, and combinations thereof.

Examples of suitable phosphorus-containing compounds include phosphates represented with reference to the formula:

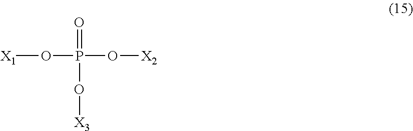

In formula (15), X₁, X₂, and X₃ can be the same or different, and, in some embodiments, at least one of X₁, X₂, and X₃ is an organic group including from 1 to 20 carbon atoms. For other embodiments, at least one of X₁, X₂, and X₃ is an organic group including more than 20 carbon atoms. X₁, X₂, and X₃ can be independently selected from, for example, hydride group, halo groups, hydroxy group, thio group, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenyl carbonylamino groups, alkynylcarbonylamino groups, N-substituted alkynylcarbonylamino groups, arylcarbonylamino groups, N-substituted arylcarbonylamino groups, silyl groups, siloxy groups, and fluorinated groups.

Examples of suitable phosphorus-containing compounds include, but are not limited to: Dibromotriphenyl phosphorane, Dimethyldiphenyl phosphonium iodide, Hexamethyl phosphoramide, Phosphorus(III) iodide, t-Butyldichlorophosphine, Tetraphenylphosphonium bromide, Tributyl phosphate, Trimethyl phosphite, Trimethyl phosphate, Tris(1,1,1,3,3,3-hexafluoro-2-propyl)phosphite, Boron phosphate, Lithium phosphate and combinations thereof.

Examples of suitable sulfur-containing compounds include sulfonates represented with reference to the formula:

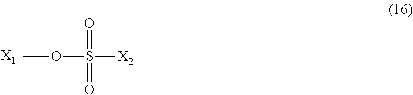

In formula (16), X₁ and X₂ can be the same or different, and, in some embodiments, at least one of X₁ and X₂ is an organic group including from 1 to 20 carbon atoms. For other embodiments, at least one of X₁ and X₂ is an organic group including more than 20 carbon atoms. X₁ and X₂ can be independently selected from, for example, hydride group, halo groups, hydroxy group, thio group, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups.

Additional examples of suitable sulfur-containing compounds include acyclic and cyclic sulfones represented with reference to the formulas:

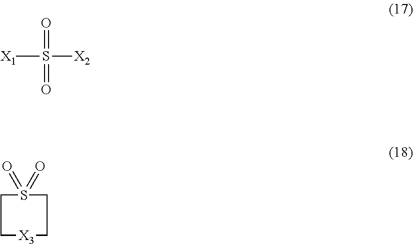

In formula (17), X₁ and X₂ can be the same or different, and, in some embodiments, at least one of X₁ and X₂ is an organic group including from 1 to 20 carbon atoms. For other embodiments, at least one of X₁ and X₂ is an organic group including more than 20 carbon atoms. X₁ and X₂ can be independently selected from, for example, hydride group, halo groups, hydroxy group, thio group, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups. In formula (18), X₃ is a bivalent, organic group including from 1 to 20 carbon atoms in some embodiments, and, for other embodiments, X₃ is a bivalent, organic group including more than 20 carbon atoms. X₃ can be selected from, for example, alkylene groups, alkenylene groups, and alkynylene groups.

A particular example of a sulfone according to formula (18) is Sulfolane represented with reference to the formula:

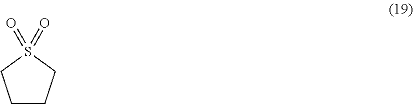

In formula (19), it is contemplated that one or more of the hydrogen atoms can be modified, such as by substituting with another chemical element or functional group, or can be replaced by an alkyl group, an alkenyl group, an alkynyl group, or an aryl group, either in a substituted or an unsubstituted form. Other functionalizations or modifications are contemplated, including increasing or decreasing the number of carbon atoms in the ring structure of the sulfone set forth in formula (19).

Examples of suitable sulfur-containing compounds include, but are not limited to: (2S)-2-methylthietane 1,1-dioxide, Butyl ethyl sulfone, Butyl phenyl sulfone, Ethyl methyl sulfone, Isopropyl sulfone, Ethylene trithiocarbonate, Trimethyl sulfone, Dibutyl sulfide, Diethyl sulfide, 1,3-Propane sultone, 1,3,2-Dioxathiolane 2,2-dioxide, 1,4-Butane sultone, Dimethyl sulfate, and combinations thereof.

Examples of suitable salts include those represented with reference to the formula:

(M)ₘ(X)ₓ (20)

In formula (20), M is a cation or other positively charged moiety corresponding to, or derived from, a transition metal or a rare earth element, X is an anion or other negatively charged moiety corresponding to, or derived from, a halogen, a chalcogen, a carboxylic acid, an alcohol, or a ketone, and m and x are integers selected in accordance with oxidation states of M and X to maintain electroneutrality, such as integers in the range of 1 to or 1 to 3. In some embodiments, X includes from 1 to 20 carbon atoms, and, for other embodiments, X includes more than 20 carbon atoms. It is contemplated that a salt according to formula (20) can include multiple and different M's selected from cationic forms of transition metals and rare earth elements, and can include multiple and different X's selected from anionic forms of halogens, chalcogens, carboxylic acids, alcohols, and ketones.

A particular example of a salt according to formula (20) is a rare earth fluoride, namely lanthanum trifluoride represented with reference to the formula:

LaF₃ (21)

In formula (21), it is contemplated that lanthanum can be replaced with another rare earth element or a transition metal, and fluoride can be partially or fully substituted with other halogens and chalcogens. Other modifications of the salt set forth in formula (21) are contemplated.

Examples of suitable salts include, but are not limited to: Barium acetylacetonate, Barium i-propoxide, Barium stearate, Calcium acetylacetonate, Calcium stearate, Magnesium acetylacetonate, Magnesium ethoxide, Magnesium trifluoroacetylacetonate dihydrate, Strontium acetylacetonate, Strontium i-propoxide, Cerium(III) acetylacetonate, Cerium(III) stearate, Chromium(II) fluoride, Chromium(III) acetylacetonate, Cobalt stearate, Cobalt(III) acetylacetonate, Copper(II) acetylacetonate, Copper(II) i-butyrate, Iron(II) fluoride, Lanthanum(III) acetylacetonate, Lanthanum(III) fluoride, Manganese(II) acetylacetonate, Manganese(III) acetylacetonate, Nickel(II) acetylacetonate, Nickel(II) stearate, Niobium(V) ethoxide, Niobium(V) fluoride, Tantalum(V) ethoxide, Titanium Ethoxide, Vanadium(III) acetylacetonate, Vanadium(V) tri-i-propoxy oxide, Yttrium(III) i-propoxide, Zinc 2-ethylhexanoate, Zinc acetylacetonate, Zirconium(IV) acetylacetonate, Zirconium(IV) ethoxide, Zirconium(IV) i-propoxide, Niobium(V) ethoxide, Niobium(V) fluoride, Lithium acetate, Lithium carbonate, Lithium phosphate, and combinations thereof.

Examples of suitable anhydride compounds include compounds represented with reference to the formula:

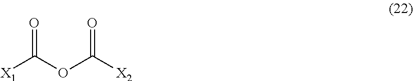

In formula (22), X₁ and X₂ can be the same or different, and, in some embodiments, at least one of X₁ and X₂ is an organic group including from 1 to 20 carbon atoms. For other embodiments, at least one of X₁ and X₂ is an organic group including more than 20 carbon atoms. X₁ and X₂ can be independently selected from, for example, hydride group, halo groups, hydroxy group, thio group, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenylcarbonylamino groups, alkynyl carbonylamino groups, N-substituted alkynylcarbonylamino groups, arylcarbonylamino groups, N-substituted arylcarbonylamino groups, silyl groups, siloxy groups, and fluorinated groups.

Examples of suitable anhydrides include, but are not limited to: 2,2,3,3,4,4-Hexafluoropentanedioic anhydride, Diglycolic anhydride, Maleic anhydride, and combinations thereof.

It is understood that certain compounds fall into more than one family or group as described in formulas (3) through (22) and the associated description. Without being bound by a particular theory or mode of action, the additives can facilitate the formation of a film, layer, coating, or region on or within electrode materials. Such film formation is described in more detail below.

Referring back to formulas (1) and (2), an amount of a particular compound can be expressed in terms of a weight percent of the compound relative to a total weight of the electrolyte solution (or wt. %). For example, an amount of a compound can be in the range of about 0.01 wt. % to about 30 wt. %, such as from about 0.05 wt. % to about 30 wt. %, from about 0.01 wt. % to about 20 wt. %, from about 0.2 wt. % to about 15 wt. %, from about 0.2 wt. % to about 10 wt. %, from about 0.2 wt. % to about 5 wt. %, or from about 5 wt. % to about 10 wt. %, and, in the case of a combination of multiple compounds, a total amount of the compounds can be in the range of about 0.01 wt. % to about 30 wt. %, such as from about 0.05 wt. % to about 30 wt. %, from about 0.01 wt. % to about 20 wt. %, from about 0.2 wt. % to about 15 wt. %, from about 0.2 wt. % to about 10 wt. %, from about 0.2 wt. % to about 5 wt. %, or from about 5 wt. % to about 10 wt. %. An amount of a compound also can be expressed in terms of a ratio of the number of moles of the compound per unit surface area of either, or both, electrode materials. For example, an amount of a compound can be in the range of about 10⁻⁷ mol/m² to about 10⁻² mol/m², such as from about 10⁻⁷ mol/m² to about 10⁻⁵ mol/m², from about 10⁻⁵ mol/m² to about 10⁻³ mol/m², from about 10⁻⁶ mol/m² to about 10⁻⁴ mol/m², or from about 10⁻⁴ mol/m² to about 10⁻² mol/m². As further described below, a compound can be consumed or can react, decompose, or undergo other modifications during initial battery cycling. As such, an amount of a compound can refer to an initial amount of the compound used during the formation of the electrolyte solutions according to formulas (1) or (2), or can refer to an initial amount of the additive within the electrolyte solution prior to battery cycling (or prior to any significant amount of battery cycling).

Resulting performance characteristics of a battery can depend upon the identity of a particular compound used to form the high voltage electrolyte according to formulas (1) or (2), an amount of the compound used, and, in the case of a combination of multiple compounds, a relative amount of each compound within the combination. Accordingly, the resulting performance characteristics can be fine-tuned or optimized by proper selection of the set of compounds and adjusting amounts of the compounds in formulas (1) or (2). Fine-tuning of an amount of an additive compound can depend upon factors such as battery configuration and characteristics of a cathode material or anode material.

The formation according to formulas (1) or (2) can be carried out using a variety of techniques, such as by mixing the base electrolyte and the set of additives, dispersing the set of additives within the base electrolyte, dissolving the set of additives within the base electrolyte, or otherwise placing these components in contact with one another. The set of additives can be provided in a liquid form, a powdered form (or another solid form), or a combination thereof. The set of additives can be incorporated in the electrolyte solutions of formulas (1) or (2) prior to, during, or subsequent to battery assembly.

The electrolyte solutions described herein can be used for a variety of batteries containing a high voltage cathode or a low voltage cathode, and in batteries operated at high temperatures. For example, the electrolyte solutions can be substituted in place of, or used in conjunction with, conventional electrolytes for Li-ion batteries for operations at or above 4.2 V.

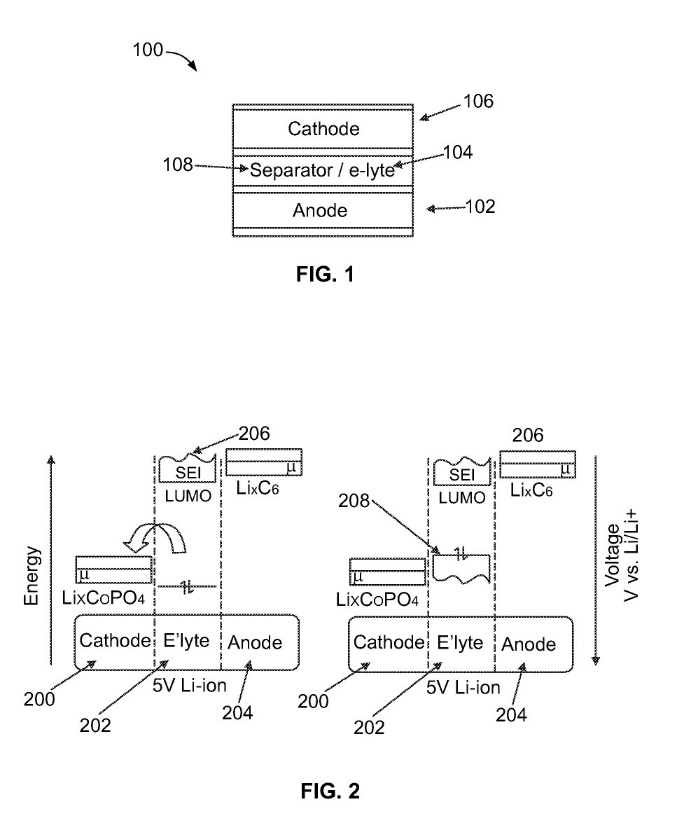

FIG. 1 illustrates a Li-ion battery 100 implemented in accordance with an embodiment of the invention. The battery 100 includes an anode 102, a cathode 106, and a separator 108 that is disposed between the anode 102 and the cathode 106. In the illustrated embodiment, the battery 100 also includes a high voltage electrolyte 104, which is disposed between the anode 102 and the cathode 106 and remains stable during high voltage battery cycling.

The operation of the battery 100 is based upon reversible intercalation and de-intercalation of Li ions into and from host materials of the anode 102 and the cathode 106. Other implementations of the battery 100 are contemplated, such as those based on conversion chemistry. Referring to FIG. 1, the voltage of the battery 100 is based on redox potentials of the anode 102 and the cathode 106, where Li ions are accommodated or released at a lower potential in the former and a higher potential in the latter. To allow both a higher energy density and a higher voltage platform to deliver that energy, the cathode 106 includes an active cathode material for high voltage operations at or above 4.2 V. Suitable high voltage cathode materials include those having a specific capacity of at least about 10 mAh/g, at least about 20 mAh/g, at least about 30 mAh/g, at least about 40 mAh/g, or at least about 50 mAh/g, as measured upon discharge at a rate of 0.1C (or another reference rate higher or lower than 0.1C, such as 0.05C, 0.5C, or 1C) from about 6 V to about 4.5 V, from about 6 V to about 5 V, from about 5.5 V to about 4.5 V, or from about 5 V to about 4.5 V relative to a lithium metal anode (Li/Li⁺ anode) or other counterelectrode. Suitable high voltage cathode materials also include those having a specific capacity of at least about 10 mAh/g, at least about 20 mAh/g, at least about 30 mAh/g, at least about 40 mAh/g, or at least about 50 mAh/g, as measured upon discharge at a substantially constant current of 15 mA/g (or another reference current higher or lower than 15 mA/g, such as 7.5 mA/g, 75 mA/g, or 150 mA/g) from about 6 V to about 4.5 V, from about 6 V to about 5 V, from about 5.5 V to about 4.5 V, or from about 5 V to about 4.5 V relative to a lithium metal anode (Li/Li⁺ anode) or other counterelectrode. The stated values for specific capacity and current can be per unit mass of a cathode active material, and can be expressed in units of mAh/(g of the cathode active material) and mA/(g of the cathode active material), respectively. Examples of suitable high voltage cathode materials include phosphates, fluorophosphates, fluorosulphates, fluorosilicates, spinels, Li-rich layered oxides, and composite layered oxides. Further examples of suitable cathode materials include: spinel structure lithium metal oxides, layered structure lithium metal oxides, lithium-rich layered structured lithium metal oxides, lithium metal silicates, lithium metal phosphates, metal fluorides, metal oxides, sulfur, and metal sulfides. Examples of suitable anode materials include conventional anode materials used in Li-ion batteries, such as lithium, graphite (“LiₓC₆”), and other carbon, silicate, or oxide-based anode materials.

For example, a class of suitable high voltage phosphates can be represented as: Liₐ(M1_{b}M2_{c}M3_{d}M4_{c})_{f}PO₄, where M1, M2, M3, and M4 can be the same or different, M1 is Mn, Co, or Ni, M2 is a transition metal, such as Ti, V, Cr, Mn, Fe, Co, Ni, Zr, Nb, or Mo, M3 is a transition metal or a main group element, optionally excluding elements of Group VIA and Group VIIA, M4 is a transition metal or a main group element, optionally excluding elements of Group VIA and Group VIIA, 1.2≧a≧0.9 (or 1.2>a>0.9), 1≧b≧0.6 (or 1>b>0.6), 0.4≧c≧0 (or 0.4>c>0), 0.2≧d≧0 (or 0.2>d>0), 0.2≧e≧0 (or 0.2>e>0), and 1.2≧f≧0.9 (or 1.2>f>0.9). Additional details regarding this class of cathode materials can be found in Goodenough et al., “Challenges for Rechargeable Li Batteries,” Chemistry of Materials 22, 587-603 (2010); Marom et al., “A review of advanced and practical lithium battery materials,” J. Mater. Chem., 21, 9938 (2011); Zhi-Ping et al., “Li-Site and Metal-Site Ion Doping in Phosphate-Olivine LiCoPO₄ by First-Principles Calculation,” Chin. Phys. Lett. 26 (3) 038202 (2009); and Fisher et al., “Lithium Battery Materials LiMPO₄ (M) Mn, Fe, Co, and Ni): Insights into Defect Association, Transport Mechanisms, and Doping Behavior,” Chem. Mater. 2008, 20, 5907-5915; the disclosures of which are incorporated herein by reference in their entirety.

For example, another class of suitable high voltage phosphates can comprise lithium (Li), cobalt (Co), a first transition metal (M1), a second transition metal (M2) different from M1, and phosphate (PO₄), where M1 and M2 are each selected from iron (Fe), titanium (Ti), vanadium (V), niobium (Nb), zirconium (Zr), hafnium (Hf), molybdenum (Mo), tantalum (Ta), tungsten (W), manganese (Mn), copper (Cu), chromium (Cr), nickel (Ni), and zinc (Zn) (e.g., as dopants and/or oxides thereof), and can have molar ratios of Li:Co:M1:M2:PO₄ defined by (1−x):(1−y−z):y:z:(1-a), respectively, optionally represented (as a shorthand notation) as: Li₍₁₋ₓ₎: Co_{(1-y-z)}: M1_{y}:M2_{z}:(PO₄)₍₁₋ₐ₎, where −0.3≦x≦0.3; 0.01≦y≦0.5; 0.01≦z≦0.3; −0.5≦a≦0.5; and 0.2≦1−y−z≦0.98. Preferably, M1 and M2 are each selected from iron (Fe), titanium (Ti), vanadium (V) and niobium (Nb) (e.g., as dopants and/or oxides thereof). Preferably, M1 is iron (Fe) (e.g., as a dopant and/or oxide thereof), M2 is selected from titanium (Ti), vanadium (V), and niobium (Nb) (e.g., as dopants and/or oxides thereof). Preferably, −0.3≦x≦0, −0.2≦x≦0, or −0.1≦x≦0. Preferably, M2 is Ti, and 0.05≦z≦0.25 or 0.05≦z≦0.2. Preferably, M2 is V, and 0.03≦z≦0.25 or 0.05≦z≦0.2. Preferably, 0.3≦1−y-z≦0.98, 0.5≦1−y−z≦0.98, or 0.7≦1−y−z≦0.98. Additional details regarding this class of olivine cathode materials can be found in co-pending and co-owned U.S. Provisional Application No. 61/426,733, entitled “Lithium Ion Battery Materials with Improved Properties” and filed on Dec. 23, 2010, the disclosure of which is incorporated herein by reference in its entirety.

For example, a class of suitable high voltage fluorophosphates can be represented as: Liₐ(M1_{b}M2_{c}M3_{d}M4_{c})_{f}PO₄F_{g}, where M1, M2, M3, and M4 can be the same or different, M1 is Mn, Co, or Ni, M2 is a transition metal, such as Ti, V, Cr, Mn, Fe, Co, Ni, Zr, Nb, or Mo, M3 is a transition metal or a main group element, optionally excluding elements of Group VIA and Group VIIA, M4 is a transition metal or a main group element, optionally excluding elements of Group VIA and Group VIIA, 1.2≧a≧0.9 (or 1.2>a>0.9), 1≧b≧0.6 (or 1>b>0.6), 0.4≧c≧0 (or 0.4>c>0), 0.2≧d≧0 (or 0.2>d>0), 0.2≧e≧0 (or 0.2>e>0), 1.2≧f≧0.9 (or 1.2>f>0.9), and 1.2≧g≧0 (or 1.2>g>0).

For example, a class of suitable high voltage fluorosilicates can be represented as: Liₐ(M1_{b}M2_{c}M3_{d}M4e)_{f}SiO₄F, where M1, M2, M3, and M4 can be the same or different, M1 is Mn, Co, or Ni, M2 is a transition metal, such as Ti, V, Cr, Mn, Fe, Co, Ni, Zr, Nb, or Mo, M3 is a transition metal or a main group element, optionally excluding elements of Group VIA and Group VIIA, M4 is a transition metal or a main group element, optionally excluding elements of Group VIA and Group VIIA, 1.2≧a≧0.9 (or 1.2>a>0.9), 1≧b≧0.6 (or 1>b>0.6), 0.4≧c≧0 (or 0.4>c>0), 0.2≧d≧0 (or 0.2>d>0), 0.2≧e≧0 (or 0.2>e>0), and 1.2≧f≧0.9 (or 1.2>f>0.9).

For example, another class of suitable high voltage fluorosilicates can be represented as: Liₐ(M1_{b}M2_{c}M3_{d}M4_{c})_{f}SiO₄F_{g}, where M1, M2, M3, and M4 can be the same or different, M1 is Mn, Co, or Ni, M2 is a transition metal, such as Ti, V, Cr, Mn, Fe, Co, Ni, Zr, Nb, or Mo, M3 is a transition metal or a main group element, optionally excluding elements of Group VIA and Group VIIA, M4 is a transition metal or a main group element, optionally excluding elements of Group VIA and Group VIIA, 1.2≧a≧0.9 (or 1.2>a>0.9), 1≧b≧0.6 (or 1>b>0.6), 0.4≧c≧0 (or 0.4>c≧0), 0.2≧d≧0 (or 0.2>d>0), 0.2≧e≧0 (or 0.2>e>0), 1.2≧f≧0.9 (or 1.2>f>0.9), and 1.2≧g≧0 (or 1.2>g>0).

For example, a class of suitable high voltage spinels can be represented as: Liₐ(M1_{b}M2_{c}M3_{d}M4_{c})_{f}O₄, where M1, M2, M3, and M4 can be the same or different, M1 is Mn or Fe, M2 is Mn, Ni, Fe, Co, or Cu, M3 is a transition metal, such as Ti, V, Cr, Mn, Fe, Co, Ni, Zr, Nb, or Mo, and M4 is a transition metal or a main group element, optionally excluding elements of Group VIA and Group VIIA, 1.2≧a≧0.9 (or 1.2>a>0.9), 1.7≧b≧1.2 (or 1.7>b>1.2), 0.8≧c≧0.3 (or 0.8>c>0.3), 0.1≧d≧0 (or 0.1>d>0), 0.1≧e≧0 (or 0.1>e>0), and 2.2≧f≧1.5 (or 2.2>f>1.5). LMNO-type and LMO-type cathode materials are included in this class. Additional details regarding this class of cathode materials can be found in Goodenough et al., “Challenges for Rechargeable Li Batteries,” Chemistry of Materials 22, 587-603 (2010); Marom et al., “A review of advanced and practical lithium battery materials,” J. Mater. Chem., 21, 9938 (2011); and Yi et al., “Recent developments in the doping of LiNi_{0.5}Mn₅O₄ cathode material for 5 V lithium-ion batteries,” Ionics (2011) 17:383-389; the disclosures of which are incorporated herein by reference in their entirety.

For example, a class of suitable high voltage, Li-rich layered oxides can be represented as: Li(LiₐM1_{b}M2_{c}M3_{d}M4_{c})_{f}O₂, where M1, M2, M3, and M4 can be the same or different, M1 is a transition metal, such as Mn, Fe, V, Co, or Ni, M2 is a transition metal, such as Mn, Fe, V, Co, or Ni, M3 is a transition metal, such as Mn, Fe, V, Co, or Ni, M4 is a transition metal or a main group element, optionally excluding elements of Group VIA and Group VIIA, 0.4≧a≧0.05 (or 0.4>a>0.05), 0.7≧b≧0.1 (or 0.7>b>0.1), 0.7≧c≧0.1 (or 0.7>c>0.1), 0.7≧d≧0.1 (or 0.7>d>0.1), 0.2≧e≧0 (or 0.2>e>0), and 1.2≧f≧0.9 (or 1.2>f>0.9). OLO-type cathode materials are included in this class. Additional details regarding this class of cathode materials can be found in Goodenough et al., “Challenges for Rechargeable Li Batteries,” Chemistry of Materials 22, 587-603 (2010); Marom et al., “A review of advanced and practical lithium battery materials” J. Mater. Chem., 21, 9938 (2011); Johnson et al., “Synthesis, Characterization and Electrochemistry of Lithium Battery Electrodes: xLi₂MnO₃ (1−x)LiMn_{0.333}Ni_{0.333}Cu_{0.333}O₂ (0≦x≦0.7),” Chem. Mater., 20, 6095-6106 (2008); and Kang et al., “Interpreting the structural and electrochemical complexity of 0.5Li₂ MnO₃.0.5LiMO₂ electrodes for lithium batteries (M=Mn_{0.5-x}Ni_{0.5-x}Co₂ₓ, 0=x=0.5),” J. Mater. Chem., 17, 2069-2077 (2007); the disclosures of which are incorporated herein by reference in their entirety.

For example, a class of suitable high voltage, composite layered oxides can be represented as: (Li₂M1ₐM2_{b}O₃)_{c} (LiM3_{d}M4_{c}M5_{f}O₂)_{g}, where M1, M2, M3, M4, and M5 can be the same or different, M1 is a transition metal, such as Mn, Fe, V, Co, or Ni, M2 is a transition metal, such as Mn, Fe, V, Co, or Ni, M3 is a transition metal, such as Mn, Fe, V, Co, or Ni, M4 is a transition metal, such as Mn, Fe, V, Co, or Ni, M5 is a transition metal or a main group element, optionally excluding elements of Group VIA and Group VIIA, 1.1≧a≧0 (or 1.1>a>0), 0.5≧b≧0 (or 0.5>b>0), 0.7≧c≧0 (or 0.7>c≧0), 1≧d≧0 (or 1>d>0), 1≧e≧0 (or 1>e>0), 1≧f≧0 (or 1>f>0), and 1≧g≧0.5 (or 1>g>0.5). Additional details regarding this class of cathode materials can be found in Goodenough et al., “Challenges for Rechargeable Li Batteries,” Chemistry of Materials 22, 587-603 (2010); Marom et al., “A review of advanced and practical lithium battery materials,” J. Mater. Chem., 21, 9938 (2011); Johnson et al., “Synthesis, Characterization and Electrochemistry of Lithium Battery Electrodes: xLi₂MnO₃ (1−x)LiMn_{0.333}Ni_{0.333}Co_{0.333}O₂ (0<x<0.7),” Chem. Mater., 20, 6095-6106 (2008); and Kang et al., “Interpreting the structural and electrochemical complexity of 0.5Li₂ MnO₃.0.5LiMO₂ electrodes for lithium batteries (M=Mn_{0.5-x}Ni_{0.5-x}Co₂ₓ, 0=x=0.5),” J. Mater. Chem., 17, 2069-2077 (2007); the disclosures of which are incorporated herein by reference in their entirety.

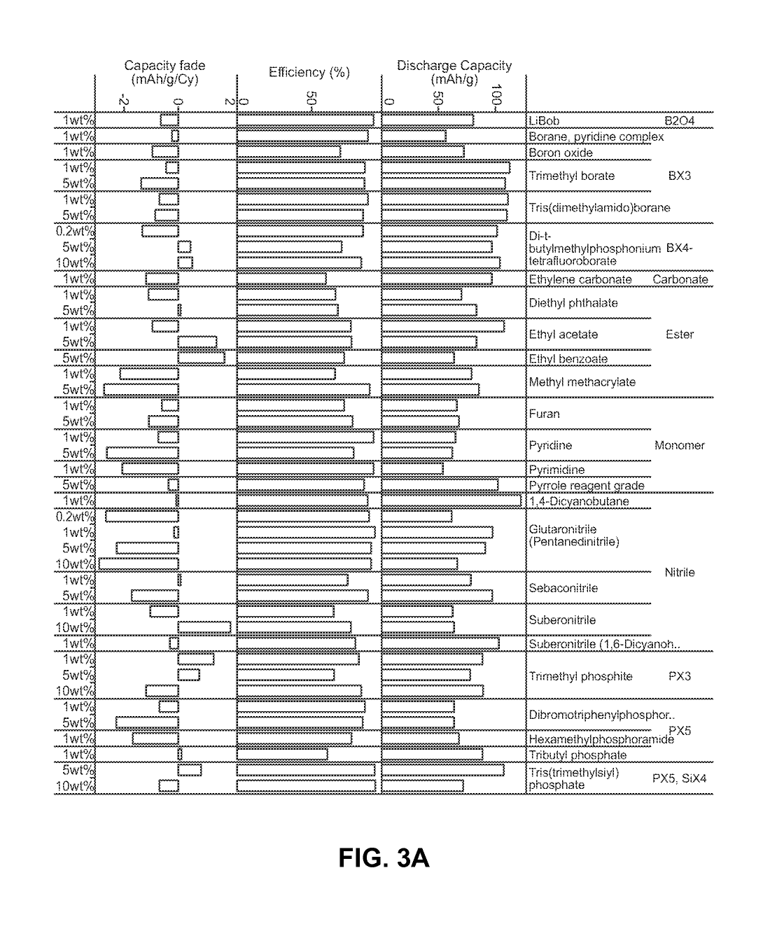

Attention next turns to FIG. 2, which illustrates operation of a Li-ion battery and an illustrative, non-limiting mechanism of action of an improved electrolyte, according to an embodiment of the invention. Without being bound by a particular theory not recited in the claims, the inclusion of a set of one or more stabilizing additive compounds in an electrolyte solution can, upon operation of the battery (e.g., during conditioning thereof) passivate a high voltage cathode material, thereby reducing or preventing reactions between bulk electrolyte components and the cathode material that can degrade battery performance.

Referring to FIG. 2, an electrolyte 202 includes a base electrolyte, and, during initial battery cycling, components within the base electrolyte can assist in the in-situ formation of a protective film (in the form of a solid electrolyte interface (“SEI”) 206) on or next to an anode 204. The anode SEI 206 can inhibit reductive decomposition of the high voltage electrolyte 202. Preferably, and without being bound by theory not recited in the claims, for operation at voltages at or above 4.2 V, the electrolyte 202 can also include a set of additives that can assist in the in-situ formation of a protective film (in the form of a SEI 208 or another derivative) on or next to a cathode 200. The cathode SEI 208 can inhibit oxidative decomposition of the high voltage electrolyte 202 that can otherwise occur during high voltage operations. As such, the cathode SEI 208 can inhibit oxidative reactions in a counterpart manner to the inhibition of reductive reactions by the anode SEI 206. In the illustrated embodiment, the cathode SEI 208 can have a thickness in the sub-micron range, and can include a set of one or more chemical elements corresponding to, or derived from, those present in the set of one or more additives, such as silicon or other heteroatom included in the set of one or more additives. Advantageously, the set of one or more additives can preferentially passivate the cathode 200 and can selectively contribute towards film formation on the cathode 200, rather than the anode 204. Such preferential or selective film formation on the cathode 200 can impart stability against oxidative decomposition, with little or no additional film formation on the anode 204 (beyond the anode SEI 206) that can otherwise degrade battery performance through resistive losses. More generally, the set of one or more additives can decompose below a redox potential of the cathode material and above a redox potential of SEI formation on the anode 204.

Without being bound by a particular theory not recited in the claims, the formation of the cathode SEI 208 can occur through one or more of the following mechanisms:

(1) The set of additive compounds can decompose to form the cathode SEI 208, which inhibits further oxidative decomposition of electrolyte components.

(2) The set of additive compounds can form an intermediate product, such as a complex with LiPF₆ or a cathode material, which intermediate product then decomposes to form the cathode SEI 208 that inhibits further oxidative decomposition of electrolyte components.

(3) The set of additive compounds can form an intermediate product, such as a complex with LiPF₆, which then decomposes during initial charging. The resulting decomposition product can then further decompose during initial charging to form the cathode SEI 208, which inhibits further oxidative decomposition of electrolyte components.

(4) The set of additive compounds can stabilize the cathode material by preventing metal ion dissolution.

Other mechanisms of action of the electrolyte 202 are contemplated, according to an embodiment of the invention. For example, and in place of, or in combination with, forming or improving the quality of the cathode SEI 208, the set of one or more additives or a derivative thereof (e.g., their decomposition product) can form or improve the quality of the anode SEI 206, such as to reduce the resistance for Li ion diffusion through the anode SEI 206. As another example, the set of one or more additives or a derivative thereof (e.g., their decomposition product) can improve the stability of the electrolyte 202 by chemically reacting or forming a complex with other electrolyte components. As a further example, the set of one or more additives or a derivative thereof (e.g., their decomposition product) can scavenge decomposition products of other electrolyte components or dissolved electrode materials in the electrolyte 202 by chemical reaction or complex formation. Any one or more of the cathode SEI 208, the anode SEI 206, and the other decomposition products or complexes can be viewed as derivatives, which can include a set of one or more chemical elements corresponding to, or derived from, those present in the set of one or more additives, such as silicon or other heteroatom included in the set of additives.

The electrolyte solutions described herein can be conditioned prior to sale or use in a commercial application. For example, batteries including the electrolyte solutions can be conditioned by cycling prior to commercial sale or use in commerce. A method of conditioning a battery can, for example, include conditioning the battery for commercial sale. Such method can include, for example, providing a battery, and cycling such battery through at least 1, at least 2, at least 3, at least 4, or at least 5 cycles, each cycle including charging the battery and discharging the battery at a rate of 0.05C (e.g., a current of 7.5 mA/g) between 4.95 V and 2.0 V (or another voltage range) versus a reference counterelectrode, such as a graphite anode. Charging and discharging can be carried out at a higher or lower rate, such as at a rate of 0.1C (e.g., a current of 15 mA/g), at a rate of 0.5C (e.g., a current of 75 mA/g), or at a rate of 1C (e.g., a current of 150 mA/g).

The electrochemical stability of the electrolyte in battery cells can be assessed by measuring the residual current. Residual current reflects the extent of decomposition of the electrolyte. A low residual current as compared to control demonstrates enhanced electrochemical stability. Without being bound to a particular theory or mode of action, electrolytes that have undergone decomposition will allow current to flow while a battery cell is held at a constant voltage due at least in part to the electrolyte decomposition products present in the electrolyte solution. Additive compounds according to embodiments of the invention improve the performance of electrolytes by any of the mechanisms proposed herein under conditions that may ordinarily cause electrolyte decomposition. Such improvements in electrochemical stability help solve problems present in known electrolyte solutions. Additive compounds according to certain embodiments reduce the residual current in a battery as compared to a control battery by at least about 10% at high voltages and/or high temperatures. Additive compounds according to certain embodiments reduce the residual current in a battery as compared to a control battery by at least about 15% at high voltages and/or high temperatures. Additive compounds according to certain embodiments reduce the residual current in a battery as compared to a control battery by at least about 20% at high voltages and/or high temperatures. Additive compounds according to certain embodiments reduce the residual current in a battery as compared to a control battery by at least about 25% at high voltages and/or high temperatures. Additive compounds according to certain embodiments reduce the residual current in a battery as compared to a control battery by at least about 30% at high voltages and/or high temperatures. Additive compounds according to certain embodiments reduce the residual current in a battery as compared to a control battery by at least about 35% at high voltages and/or high temperatures. Additive compounds according to certain embodiments reduce the residual current in a battery as compared to a control battery by at least about 40% at high voltages and/or high temperatures. Additive compounds according to certain embodiments reduce the residual current in a battery as compared to a control battery by at least about 45% at high voltages and/or high temperatures. Additive compounds according to certain embodiments reduce the residual current in a battery as compared to a control battery by at least about 50% at high voltages and/or high temperatures. Additive compounds according to certain embodiments reduce the residual current in a battery as compared to a control battery by at least about 55% at high voltages and/or high temperatures. Additive compounds according to certain embodiments reduce the residual current in a battery as compared to a control battery by at least about 60% at high voltages and/or high temperatures. Additive compounds according to certain embodiments reduce the residual current in a battery as compared to a control battery by at least about 65% at high voltages and/or high temperatures. Additive compounds according to certain embodiments reduce the residual current in a battery as compared to a control battery by at least about 70% at high voltages and/or high temperatures. Additive compounds according to certain embodiments reduce the residual current in a battery as compared to a control battery by at least about 75% at high voltages and/or high temperatures. Additive compounds according to certain embodiments reduce the residual current in a battery as compared to a control battery by at least about 80% at high voltages and/or high temperatures. Additive compounds according to certain embodiments reduce the residual current in a battery as compared to a control battery by at least about 85% at high voltages and/or high temperatures. Additive compounds according to certain embodiments reduce the residual current in a battery as compared to a control battery by at least about 90% at high voltages and/or high temperatures. Additive compounds according to certain embodiments reduce the residual current in a battery as compared to a control battery by at least about 95% at high voltages and/or high temperatures. Additive compounds according to certain embodiments reduce the residual current in a battery as compared to a control battery by at least about 100% at high voltages and/or high temperatures.

As will be appreciated from the many examples that follow, additive compounds of certain embodiments of the invention improve the performance of conventional electrolytes in high voltage cells both at room temperatures and at high temperatures. Further, compounds of certain embodiments of the invention improve the performance of conventional electrolytes in low voltage cells at high temperatures.

Additive compounds according to certain embodiments improve the residual current over the control electrolyte in a high voltage cell at room temperature and/or at high temperature. For example, certain anhydride-containing compounds, ester-containing compounds, sulfone-containing compounds, nitrogen heteroaromatic compounds, phosphate-containing compounds, and borate-containing compounds showed such performance improvements as compared to control electrolytes in an cell using an LMO-type cathode material.

Additive compounds according to certain embodiments improve cycle life and coulombic efficiency over the control electrolyte in a high voltage cell at room temperature. For example, certain lithium salts, anhydride-containing compounds, borate-containing compounds, ester-containing compounds, and certain fluorinated compounds showed such performance improvements as compared to control electrolytes in an cell using an LMNO-type cathode material. Certain anhydride-containing compounds reduced the residual current in an electrochemical cell using an LMO-type cathode material by as much as about 67% as compared to a base electrolyte in the same type of cell. Certain sulfone compounds reduced the residual current in an electrochemical cell using an LMO-type cathode material by as much as about 42% as compared to a base electrolyte in the same type of cell. Certain monomer compounds reduced the residual current in an electrochemical cell using an LMO-type cathode material by as much as about 57% as compared to a base electrolyte in the same type of cell. Certain salt-containing compounds reduced the residual current in an electrochemical cell using an LMO-type cathode material by as much as about 43% as compared to a base electrolyte in the same type of cell.

### EXAMPLES

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Example 1

### Methodology for Formation and Characterization of Battery Cells Including Stabilizing Additives

Battery cells were formed in a high purity argon filled glove box (M-Braun, O₂ and humidity content<0.1 ppm). Initially, poly(vinylidene fluoride) (Sigma Aldrich), carbon black (Super P Li, TIMCAL), and a doped LiCoPO₄ cathode material (Li₍₁₋ₓ₎: Co_{(1-y-z)}:Fe_{y}:Ti_{z}:(PO₄)₍₁₋ₐ₎) were mixed in 1-methyl-2-pyrrolidinone (Sigma Aldrich), and the resulting slurry was deposited on an aluminum current collector and dried to form a composite cathode film. A lithium or graphite anode was used. In case of a graphite anode, a graphitic carbon (mesocarbon microbeads or MCMB) was mixed with poly(vinylidene fluoride) (Sigma Aldrich), carbon black (Super P Li, TIMCAL), using 1-methyl-2-pyrrolidinone (Sigma Aldrich) as a solvent, and the resulting slurry was deposited on a copper current collector and dried to form a composite anode film. Each battery cell including the composite cathode film, a Millipore glass fiber or a polypropylene separator, and the lithium or graphite anode was assembled in a coin cell-type assembly (CR2025, Hohsen). A conventional electrolyte was mixed with a stabilizing additive compound and added to the battery cell. The battery cell was sealed and cycled between a particular voltage range (e.g., about 2 V to about 4.95 V) at a particular temperature (e.g., room temperature or 25° C.).

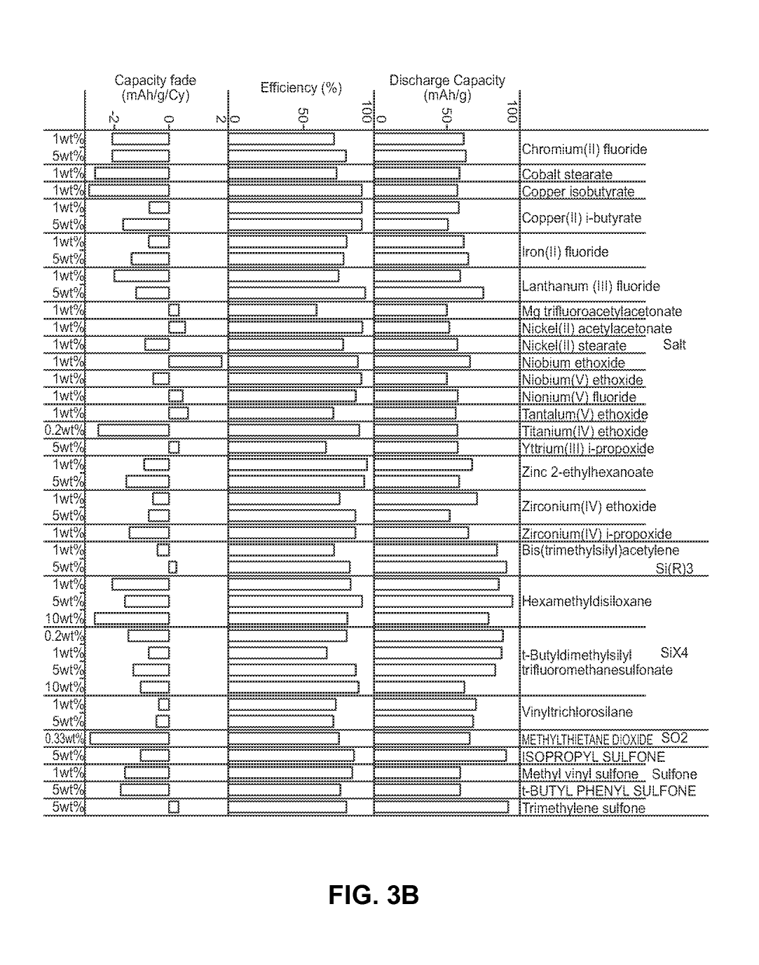

Table 1 below sets forth performance characteristics measured for battery cells including different stabilizing additives, expressed in terms of an average specific capacity upon discharge (over cycles 5 through 15), an average coulombic efficiency (over cycles 5 through 15), and an average capacity fade per cycle (over cycles 1 through 10). FIG. 3A and FIG. 3B set forth similar performance characteristics measured for a subset of the stabilizing additives. In some instances, measurements were carried out at different concentrations of a particular stabilizing additive in the range of about 0.2 wt. % to about 10 wt. %, such as 0.2 wt. %, 0.33 wt. %, 1 wt. %, 5 wt. %, and 10 wt. %. In FIG. 3A and FIG. 3B, average coulombic efficiencies ranged from about 60% to about 99.8%, average discharge capacities ranged from about 50 mAh/g to about 121.8 mAh/g, and average capacity fades per cycle ranged from about −3 mAh/(g·cycle) to about 1.92 mAh/(g·cycle). As can be appreciated, various stabilizing additives provided desirable performance characteristics in terms of a high discharge capacity, a high coulombic efficiency, and a low capacity fade.

TABLE 1

| | | | | | Capacity |
|---|---|---|---|---|---|
| | | | Discharge | Coulomb | fade |
| | | | Capacity | Efficiency | (mAh/g |
| | | | (mAh/g) - | (%) - | cycle) - |
| Additives | Formula | Category | Cycle 5-15 | Cycle 5-15 | Cycle 1-10 |
| Barium acetylacetonate | Ba(C₅H₇O₂)₂ | Salt | 35 | 91.6 | −0.29 |
| Barium i-propoxide | Ba(OCH(CH₃)₂)₂ | Salt | 55 | 82.3 | −0.55 |
| Barium stearate | Ba(C₁₈H₃₅O₂)₂ | Salt | 47 | 99.4 | −0.08 |
| Bis(hexyleneglycolato) | C₁₂H₂₄B₂O₄ | B₂O₄ | 39 | 80.4 | 1.50 |
| diboron | | | | | |
| Bis(pinacolato)diboron | C₁₂H₂₄B₂O₄ | B₂O₄ | 39 | 82.4 | −1.34 |
| Bis(trimethylsilyl) | (CH₃)₃SiC≡CSi(CH₃)₃ | Si(R)₃ | 91 | 83.6 | 0.19 |
| acetylene | | | | | |
| Borane, pyridine | C₅H₈BN | BX₃ | 55 | 88.3 | −0.26 |
| complex | | | | | |
| Boron fluoride, ethyl | BF₃•C₄H₁₀O | BX₃ | 41 | 87.2 | 1.37 |
| ether complex (47-48% | | | | | |
| Boron fluoride) | | | | | |
| Boron oxide | B₂O₃ | BX₃ | 71 | 69.5 | −0.76 |
| Calcium | Ca(C₅H₇O₂)₂•xH₂O | Salt | 36 | 88.1 | 0.01 |
| acetylacetonate | | | | | |
| Calcium stearate | [CH₃(CH₂)₁₆COO]₂Ca | Salt | 25 | 99.0 | 0.01 |
| Dibromotriphenyl | (C₆H₅)₃PBr₂ | PX₅ | 63 | 86.3 | −0.71 |
| phosphorane | | | | | |
| Dimethyldichlorosilane | (CH₃)₂SiCl₂ | SiX₄ | 73 | 55.1 | −0.08 |
| Dimethyldiphenyl | (C₆H₅)₂P(I)(CH₃)₂ | PX₅ | 39 | 31.9 | −1.63 |
| phosphonium iodide | | | | | |
| Di-t-butylmethyl | C₉H₂₂BF₄P | BX₄ | 104 | 84.8 | 0.49 |
| phosphonium | | | | | |
| tetrafluoroborate | | | | | |
| Hexamethyldisiloxane | (CH₃)₃SiOSi(CH₃)₃ | SiX₄ | 96 | 92.5 | −1.61 |
| Hexamethyl | [(CH₃)₂N]₃PO | PX₅ | 67 | 79.8 | −0.47 |
| phosphoramide | | | | | |
| Lithium | C₄BLiO₈ | B₂O₄ | 80 | 92.1 | −0.64 |
| bis(oxalato)borate | | | | | |
| Magnesium | [CH₃COCHC(O)CH₃]₂Mg | Salt | 38 | 76.9 | −1.18 |
| acetylacetonate | | | | | |
| Magnesium ethoxide | Mg(OC₂H₅)₂ | Salt | 47 | 93.4 | 0.97 |
| Magnesium | Mg(C₅H₄F₃O₂)₂ | Salt | 51 | 61.1 | 0.31 |
| trifluoroacetylacetonate | | | | | |
| dihydrate | | | | | |
| Phosphorus(III) iodide | PI₃ | PX₃ | 45 | 18.7 | −2.14 |
| Strontium | [CH₃COCH═C(O)CH₃]₂Sr | Salt | 52 | 52.6 | 1.78 |
| acetylacetonate | | | | | |
| Strontium i-propoxide | C₆H₁₄O₂Sr | Salt | 48 | 33.5 | −1.84 |
| t- | C₄H₉Cl₂P | PX₃ | 56 | 39.3 | 0.44 |
| Butyldichlorophosphine | | | | | |
| t-Butyldimethylsilyl | CF₃SO₃Si(CH₃)₂C(CH₃)₃ | SiX₄ | 89 | 89.8 | −0.75 |
| trifluoromethane | | | | | |
| sulfonate | | | | | |
| Tetramethyl | Si(OCH₃)₄ | SiX₄ | 41 | 84.6 | 1.41 |
| orthosilicate | | | | | |
| Tetraphenylphosphonium | (C₆H₅)₄P(Br) | PX₅ | 58 | 52.6 | 1.98 |
| bromide | | | | | |
| Tributyl phosphate | (CH₃(CH₂)₃O)₃PO | PX₅ | 88 | 61.0 | 0.10 |
| Trimethyl borate | B(OCH₃)₃ | BX₃ | 112 | 86.3 | −0.46 |
| Trimethyl phosphite | (CH₃O)₃P | PX₃ | 89 | 83.5 | 1.28 |
| Tris(dimethylamido) | B(N(CH₃)₂)₃ | BX₃ | 111 | 88.5 | −0.72 |
| borane | | | | | |
| Tris(trimethylsilyl) | [(CH₃)₃SiO]₃P(O) | PX₅, | 107 | 93.6 | 0.92 |
| phosphate | | SiX₄ | | | |
| Vinyltrichlorosilane | H₂C═CHSiCl₃ | SiX₄ | 83 | 74.4 | −0.20 |
| Vinyltriethoxysilane | H₂C═CHSi(OC₂H₅)₃ | SiX₄ | 41 | 66.5 | 1.06 |
| (2S)-2-methylthietane | C₄H₈O₂S | SO₂ | 66 | 76.2 | −2.86 |
| 1,1-dioxide | | | | | |
| 1,1-Dimethoxyethane | CH₃CH(OCH₃)₂ | Ether | 103 | 86.2 | −2.89 |
| 1,3-Dioxane | C₄H₈O₂ | Ether | 62 | 72.4 | 0.68 |
| 1,3-Dioxolane | C₃H₆O₂ | Ether | 67 | 40.2 | 0.08 |
| 1,4-Dicyanobutane | NC(CH₂)₄CN | Nitrile | 122 | 87.8 | −0.11 |
| (Adiponitrile) | | | | | |
| 1,4-Dioxane | C₄H₈O₂ | Ether | 30 | 48.7 | 0.26 |
| 2,4-Dimethyl-3- | (CH₃)₂CHCOCH(CH₃)₂ | Ketone | 79 | 40.2 | −3.45 |
| pentanone | | | | | |
| 2-Hexanone | CH₃(CH₂)₃COCH₃ | Ketone | 33 | 84.2 | −0.52 |
| 2-Methyl-1,3-dioxolane | C₄H₈O₂ | Ether | 54 | 65.4 | −0.50 |
| 2-Pentanone | CH₃COCH₂CH₂CH₃ | Ether | 74 | 84.9 | −1.05 |
| 4-Methyl-1,3-dioxolane | C₄H₈O₂ | Ether | 46 | 20.9 | 0.14 |
| butyl ethyl sulfone | C₆H₁₄O₂S | Sulfone | 67 | 38.5 | −4.05 |
| butyl phenyl sulfone | C₁₀H₁₄O₂S | Sulfone | 48 | 77.3 | −5.95 |
| Cyclohexanone | C₆H₁₀(═O) | Ketone | 25 | 76.0 | −0.83 |
| Diallyl carbonate | (H₂C═CHCH₂O)₂CO | Carbonate | 93 | 47.4 | 0.13 |
| Diethyl phthalate | C₆H₄-1,2-(CO₂C₂H₅)₂ | Ester | 82 | 68.6 | 0.06 |
| Dimethoxymethane | CH₂(OCH₃)₂ | Ether | 64 | 28.7 | −2.91 |
| Dimethyl carbonate | (CH₃O)₂CO | Carbonate | 89 | 34.2 | −3.68 |
| Ethyl acetate | CH₃COOC₂H₅ | Ester | 107 | 77.1 | 1.35 |
| Ethyl benzoate | C₆H₅COOC₂H₅ | Ester | 75 | 72.0 | 1.66 |
| Ethyl isobutyrylacetate | (CH₃)₂CHCOCH₂COOC₂H₅ | Ester | 40 | 62.6 | 0.33 |
| Ethyl methyl sulfone | C₃H₈SO₂ | Sulfone | 76 | 55.4 | −0.69 |
| Ethylene carbonate | C₃H₄O₃ | Carbonate | 96 | 60.3 | −1.17 |
| Ethylene | C₃H₄S₃ | Thiocarbonate | 29 | 10.7 | −0.31 |
| trithiocarbonate | | | | | |
| Glutaronitrile | NC(CH₂)₃CN | Nitrile | 97 | 92.9 | −0.16 |
| (Pentanedinitrile) | | | | | |
| isopropyl sulfone | C₆H₁₄O₂S | Sulfone | 91 | 87.2 | −1.05 |
| Methyl benzoate | C₆H₅COOCH₃ | Ester | 106 | 41.3 | −0.92 |
| Methyl methacrylate | CH₂═C(CH3)COOCH3 | Ester | 84 | 89.5 | −2.17 |
| Methyl vinyl sulfone | H₂C═CHSO₂CH₃ | Sulfone | 60 | 86.0 | −1.64 |
| Propylene carbonate | C₄H₆O₃ | Carbonate | 75 | 57.5 | −0.77 |
| Sebaconitrile | C₁₀H₁₆N₂ | Nitrile | 96 | 89.5 | 0.07 |
| Suberonitrile (1,6- | C₈H₁₂N₂ | Nitrile | 73 | 76.9 | 1.92 |
| Dicyanohexane) | | | | | |
| Sulfolane | C₄H₈O₂S | Sulfone | 64 | 57.8 | −4.37 |
| t-butyl phenyl sulfone | C₁₀H₁₄O₂S | Sulfone | 60 | 77.3 | −1.78 |
| Tetrahydropyran | C₅H₁₀O | Monomer | 32 | 79.7 | −0.14 |
| Trimethyl phosphate | (CH₃O)₃PO | PX₅ | 92 | 58.4 | 0.42 |
| Trimethyl sulfone | | Sulfone | 93 | 81.1 | 1.88 |
| Vinylene carbonate | C₃H₂O₃ | Carbonate | 67 | 56.0 | −0.12 |
| 3-Bromothiophene | C₄H₃BrS | Monomer | 45 | 79.4 | 0.23 |
| 3-Chlorothiophene | C₄H₃ClS | Monomer | 67 | 62.3 | 1.02 |
| 3-Iodothiophene | C₄H₃IS | Monomer | 21 | 58.5 | −0.32 |
| 3-Methylpyrrole | C₅H₇N | Monomer | 40 | 15.0 | 1.79 |
| 3-Methylthiophene | C₅H₆S | Monomer | 63 | 82.3 | 0.20 |
| Furan | C₄H₄O | Monomer | 58 | 76.3 | −0.71 |
| Piperazine | C₄H₁₀N₂ | Monomer | 69 | 96.3 | 0.25 |
| Pyridine | C₅H₅N | Monomer | 64 | 92.5 | −0.72 |
| Pyrimidine | C₄H₄N₂ | Monomer | 53 | 92.1 | −0.78 |
| Pyrrole | C₄H₅N | Monomer | 102 | 85.9 | −0.43 |
| Thiophene | C₄H₄S | Monomer | 66 | 71.4 | −1.31 |
| Cerium(III) | Ce(C₅H₇O₂)₃•xH₂O | Salt | 30 | 93.1 | −0.97 |
| acetylacetonate | | | | | |
| Cerium(III) stearate | C₅₄H₁₀₅CeO₆ | Salt | 35 | 94.3 | −2.15 |
| Chromium(II) fluoride | CrF₂ | Salt | 63 | 81.0 | −2.05 |
| Chromium(III) | C₁₅H₂₁CrO₆ | Salt | 38 | 75.5 | −0.63 |
| acetylacetonate | | | | | |
| Cobalt stearate | C₃₆H₇₀CoO₄ | Salt | 59 | 74.8 | −1.05 |
| Cobalt(III) | C₁₅H₂₁CoO₆ | Salt | 32 | 77.3 | −2.22 |
| acetylacetonate | | | | | |
| Copper(II) | Cu(C₅H₇O₂)₂ | Salt | 40 | 85.2 | −1.38 |
| acetylacetonate | | | | | |
| Copper(II) i-butyrate | C₈H₁₄CuO₄ | Salt | 65 | 92.5 | −1.20 |
| Iron(II) fluoride | FeF₂ | Salt | 65 | 82.2 | −0.77 |
| Lanthanum(III) | La(C₅H₇O₂)₃•xH₂O | Salt | 41 | 82.2 | −0.65 |
| acetylacetonate | | | | | |
| Lanthanum(III) fluoride | LaF₃ | Salt | 75 | 93.8 | −1.18 |
| Manganese(II) | [CH₃COCH═C(O)CH₃]₂Mn | Salt | 20 | 92.9 | −0.19 |
| acetylacetonate | | | | | |
| Manganese(III) | Mn(C₅H₇O₂)₃ | Salt | 29 | 99.6 | −0.78 |
| acetylacetonate | | | | | |
| Nickel(II) | Ni(C₅H₇O₂)₂ | Salt | 52 | 92.9 | 0.54 |
| acetylacetonate | | | | | |
| Nickel(II) stearate | Ni(O₂C(CH₂)₁₆CH₃)₂ | Salt | 57 | 80.0 | −0.56 |
| Niobium(V) ethoxide | C₁₀H₂₅NbO₅ | Salt | 72 | 90.1 | 1.82 |
| Niobium(V) fluoride | NbF₅ | Salt | 78 | 96.5 | 0.74 |
| Tantalum(V) ethoxide | C₁₀H₂₅TaO₅ | Salt | 56 | 72.8 | 0.63 |
| Titanium Ethoxide | C₈H₂₀O₄Ti | Salt | 57 | 93.8 | −0.76 |
| Vanadium(III) | V(C₅H₇O₂)₃ | Salt | 33 | 83.3 | −0.78 |
| acetylacetonate | | | | | |
| Vanadium(V) tri-i- | VO(OC₃H₇)₃ | Salt | 47 | 85.5 | −0.01 |
| propoxy oxide | | | | | |
| Yttrium(III) i- | Y(OCH(CH₃)₂)₃ | Salt | 57 | 68.2 | 0.30 |
| propoxide | | | | | |
| Zinc 2-ethylhexanoate | Zn[OOCCH(C₂H₅)C₄H₉]₂ | Salt | 67 | 95.7 | −0.95 |
| Zinc acetylacetonate | Zn(C₅H₇O₂)₂•xH₂O | Salt | 30 | 91.0 | −0.13 |
| Zirconium(IV) | Zr(C₅H₇O₂)₄ | Salt | 32 | 90.6 | −1.17 |
| acetylacetonate | | | | | |
| Zirconium(IV) ethoxide | Zr(OC₂H₅)₄ | Salt | 71 | 87.5 | −0.61 |
| Zirconium(IV) i- | Zr(OCH₂CH₂CH₃)₄ | Salt | 65 | 93.7 | −1.48 |
| propoxide | | | | | |
| Dibutyl Sulfide | CH₃(CH₂)₃S(CH₂)₃CH₃ | Sulfide | 40 | 82.9 | −1.52 |
| Diethyl Sulfide | (C₂H₅)₂S | Sulfide | 35 | 26.6 | 0.03 |
| Niobium(V) ethoxide | Nb(OCH₂CH₃)₅ | Salt | 50 | 92.1 | −0.16 |
| Niobium(V) fluoride | NBF₅ | Salt | 57 | 88.3 | 0.44 |

### Example 2

### Characterization of Battery Cells Including Stabilizing Additives

Performance characteristics were measured for various stabilizing additives dispersed in a conventional electrolyte (ethylene carbonate, dimethyl carbonate, and 1M LiPF₆). Each test battery cell and each control battery cell included a doped LiCoPO₄ cathode material (Li₍₁₋ₓ₎:Co_{(1-y-z)}:Fe_{y}:Ti_{z}:(PO₄)₍₁₋ₐ₎) and a lithium anode.

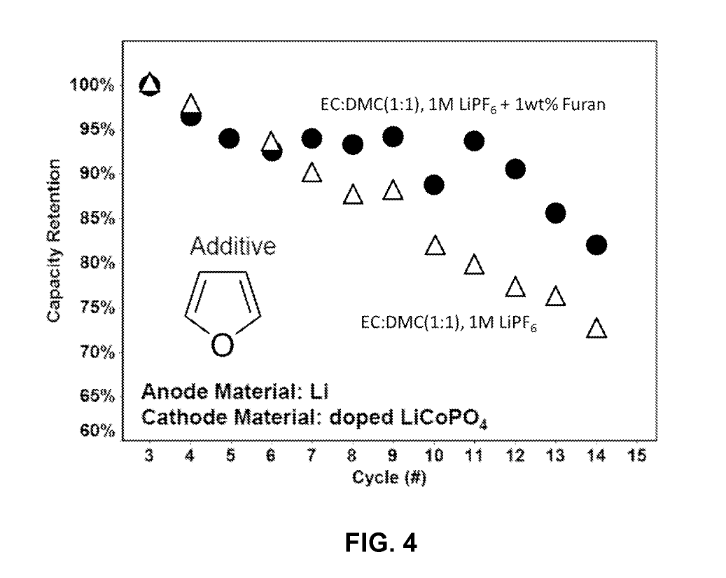

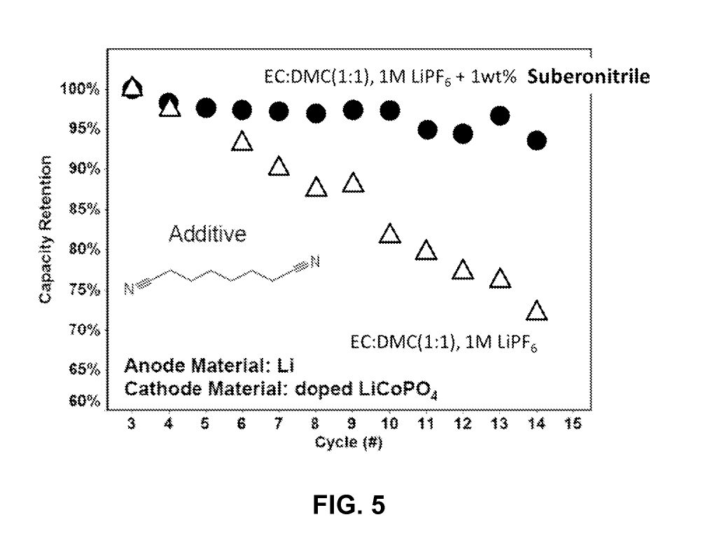

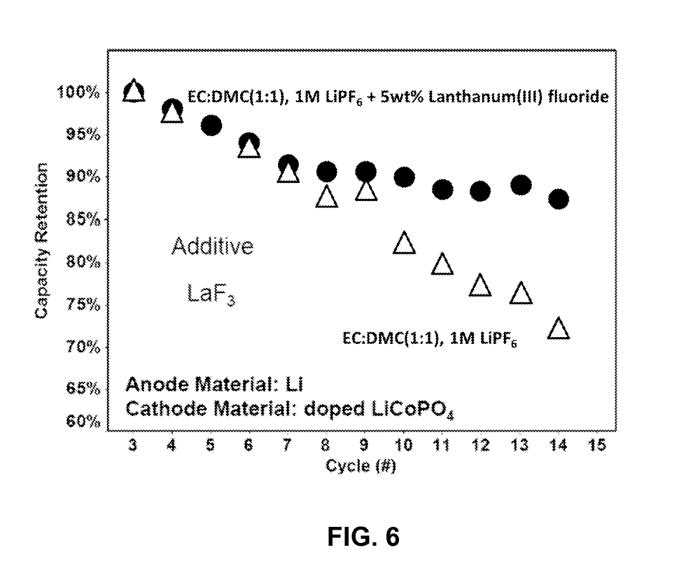

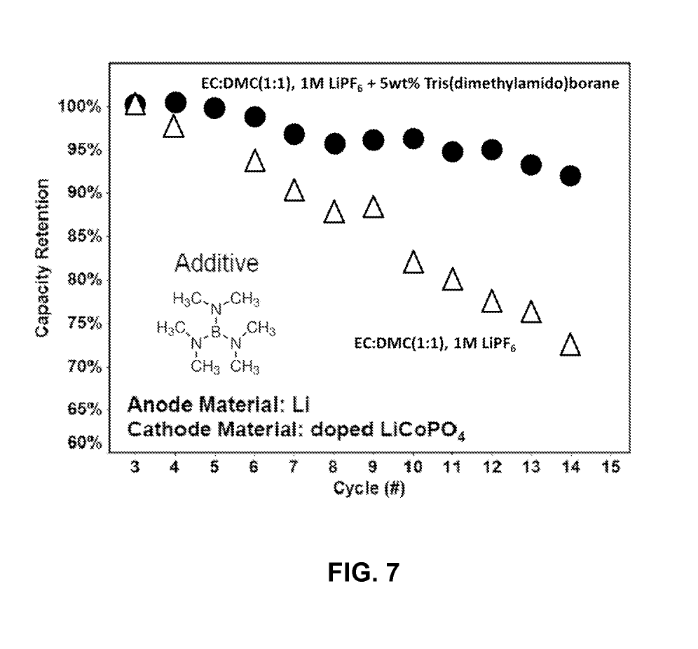

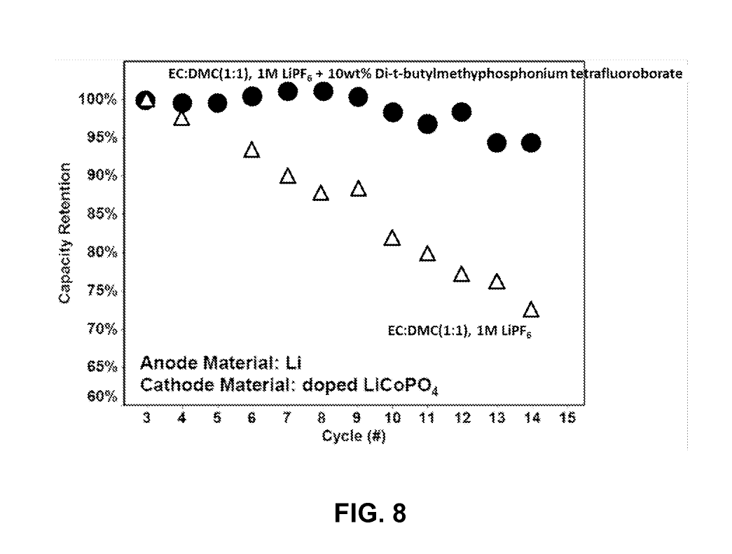

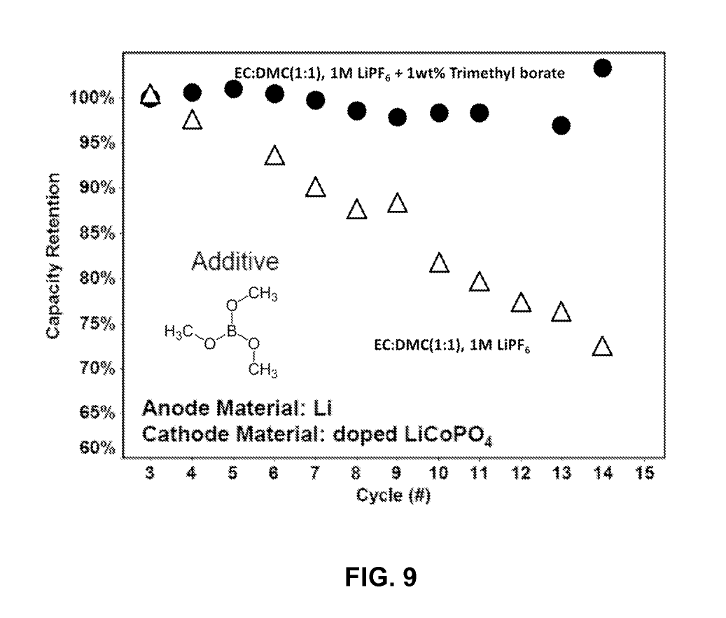

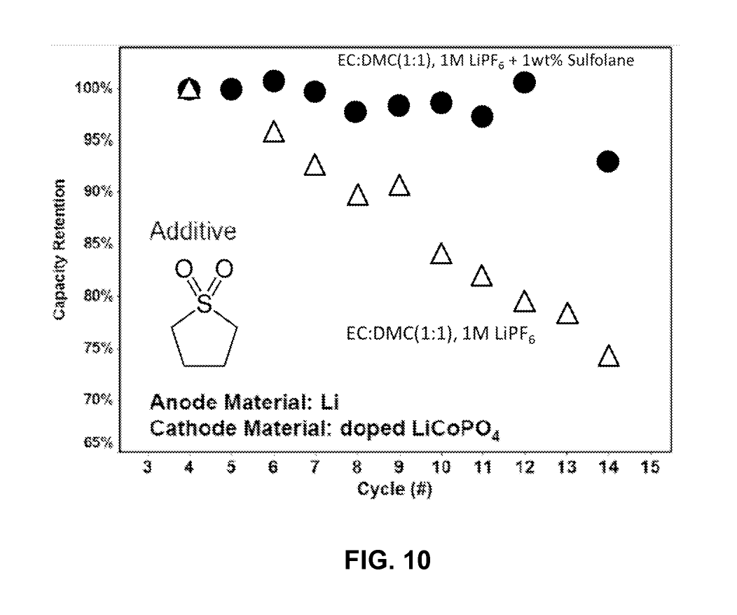

FIGS. 4 through 10 compare capacity retention with and without furan, suberonitrile, lanthanum trifluoride (or lanthanum(III) fluoride), tris(dimethylamido)borane, di-t-butylmethylphosphonium tetrafluoro borate, trimethyl borate, and sulfolane as a stabilizing additive compound over several cycles, expressed in terms of a percentage of an initial specific capacity upon discharge retained at a particular cycle. As can be appreciated, the inclusion of the stabilizing additives improved cycle life.

### Example 3

### Methodology for Formation and Characterization of Battery Cells Including Stabilizing Additives

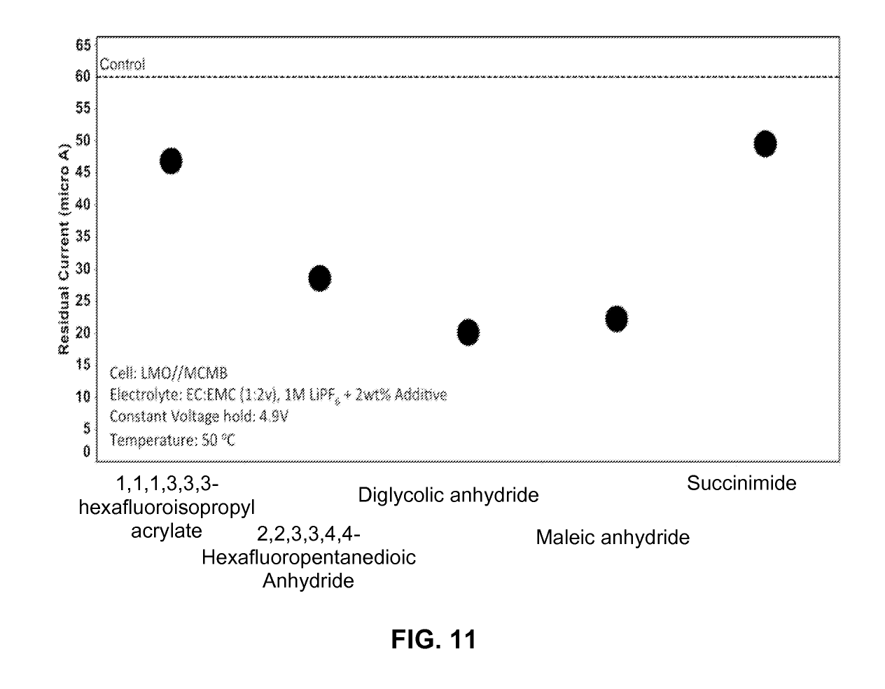

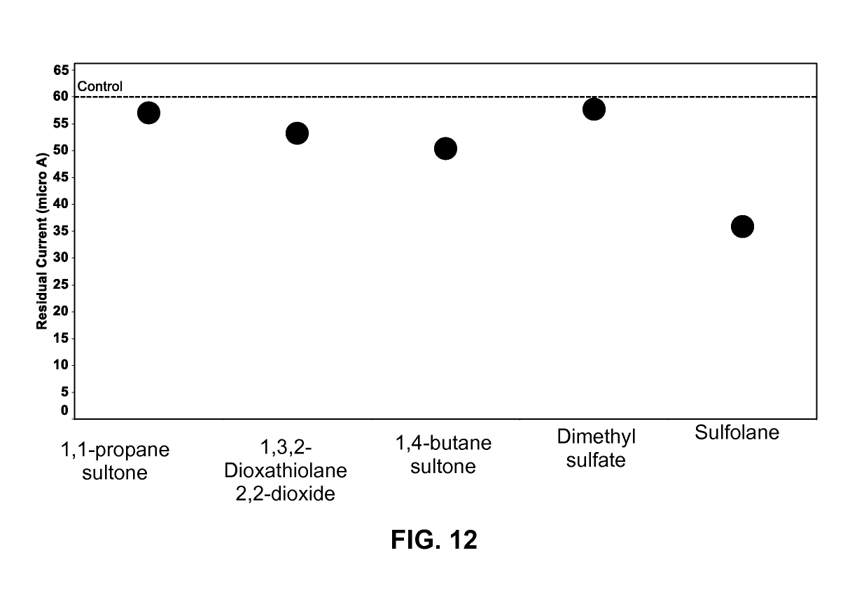

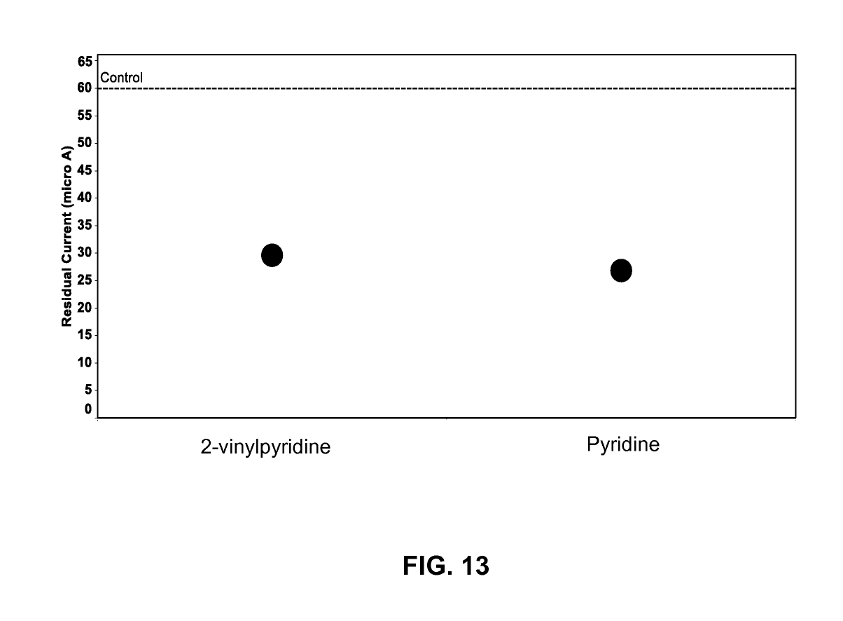

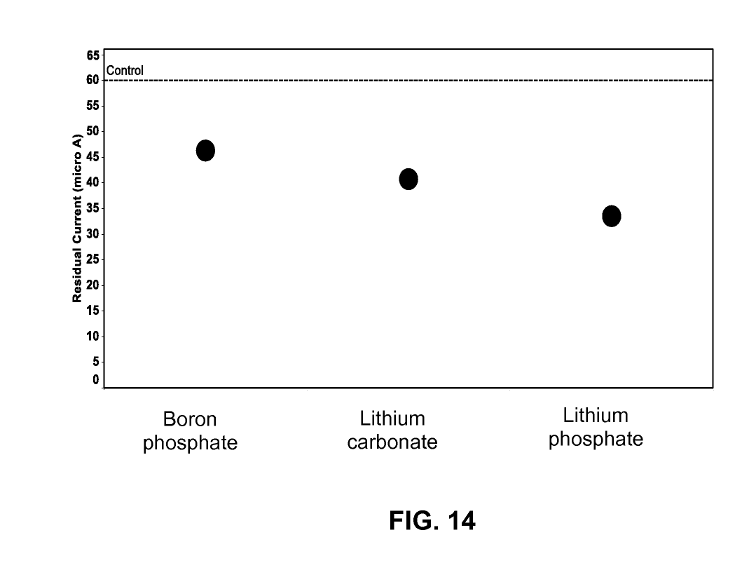

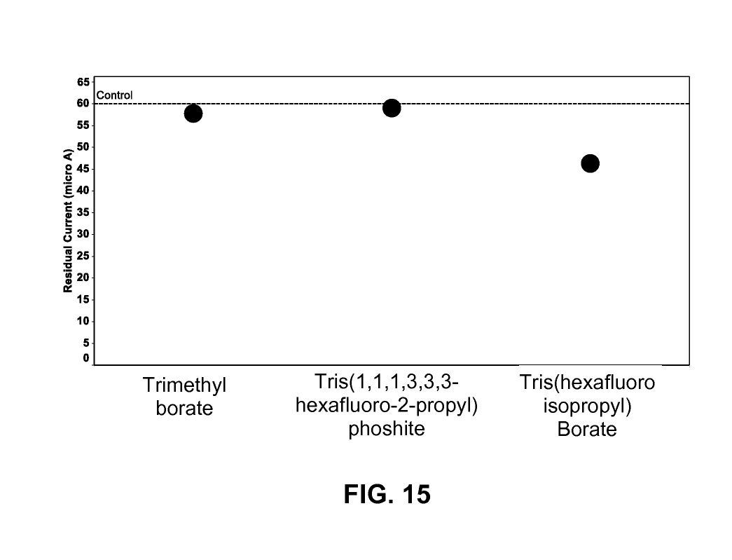

In another set of tests, performance characteristics were measured for a test battery cells including stabilizing additive compounds dispersed in a conventional electrolyte (ethylene carbonate, ethyl methyl carbonate, and 1M LiPF₆) and for a control battery cell including the conventional electrolyte but without the stabilizing additive (labeled as “EC:EMC(1:2), 1M LiPF₆”). Each of the test battery cell and the control battery cell included a LiMn₂O₄ cathode material. After a formation charge and discharge at room temperature, the battery cell was cycled nine times between about 3 V to about 4.5 V with the charge being at about 1C and a constant voltage period up to C/50 and discharge at 1C. Residual current was measured in a cycle from about 3 V to about 4.9 V when the cell was held at about 4.9 V (and 5.1 V in some cases) for 5 hours at about 50° C. The inclusion of the stabilizing additive yielded a low residual current for the LiMn₂O₄ cathode material, as can be appreciated with reference to FIG. 11 through FIG. 15.

### Example 4

### Methodology for Formation and Characterization of Battery Cells Including Stabilizing Additives

Battery cells were formed in a high purity argon filled glove box (M-Braun, O₂ and humidity content<0.1 ppm). Initially, poly(vinylidene fluoride) (Sigma Aldrich), carbon black (Super P Li, TIMCAL), and a cathode material were mixed in 1-methyl-2-pyrrolidinone (Sigma Aldrich), and the resulting slurry was deposited on an aluminum current collector and dried to form a composite cathode film. A lithium or graphite anode was used. In case of a graphite anode, a graphitic carbon was mixed with poly(vinylidene fluoride) (Sigma Aldrich), carbon black (Super P Li, TIMCAL), using 1-methyl-2-pyrrolidinone (Sigma Aldrich) as a solvent, and the resulting slurry was deposited on a copper current collector and dried to form a composite anode film. Each battery cell including the composite cathode film, a Millipore glass fiber or a polypropylene separator, and the lithium or graphite anode was assembled in a coin cell-type assembly (CR2025, Hohsen). Cells with Li anodes are tested in Hohsen CR2032 cells. A conventional electrolyte was mixed with a stabilizing additive and added to the battery cell. The battery cell was sealed and cycled between a particular voltage range for each cathode at a particular temperature (e.g., room temperature or 25° C.). The cycling voltage range for LMNO-type cathodes in a full cell was about 3 V to about 4.85 V. The upper cutoff voltage is 0.05V higher in a half cell than in a full cell.

### Example 5

### Characterization of Battery Cells Including Stabilizing Additives

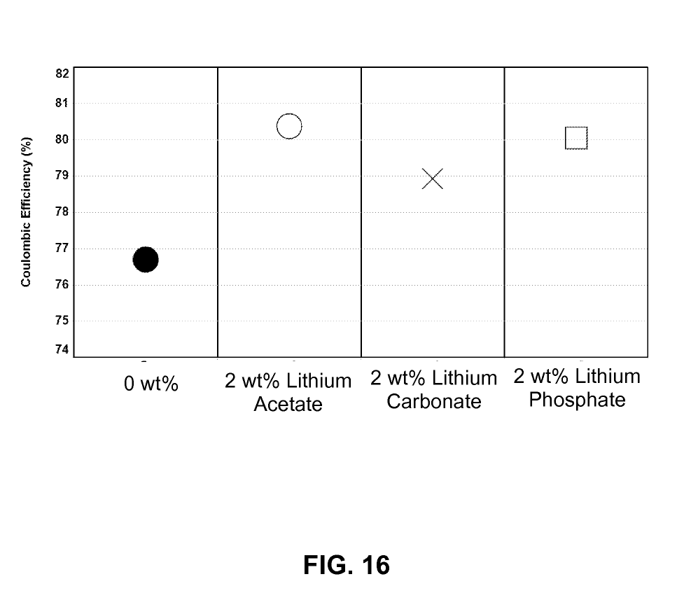

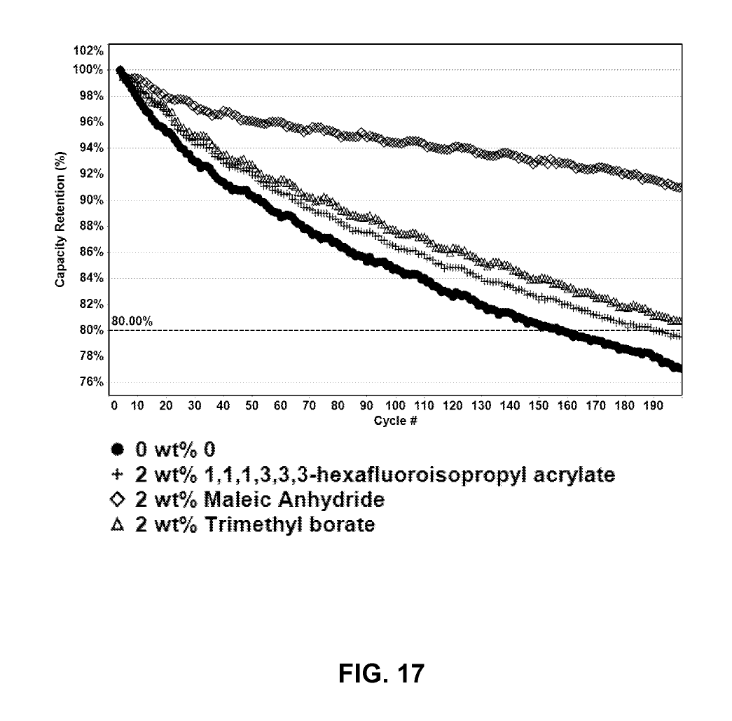

Using the methodology of Example 4, performance characteristics were measured for test battery cells including different stabilizing additives dispersed in a conventional electrolyte (ethylene carbonate, ethyl methyl carbonate, and 1M LiPF₆) and for a control battery cell including the conventional electrolyte but without a stabilizing additive. In this example, the cathode material was LMNO-type and the test was performed at room temperature. FIG. 16 compares coulombic efficiency of the battery cells at the first cycle. FIG. 17 compares capacity retention of the battery cells over several cycles, expressed in terms of a percentage of an initial specific capacity upon discharge retained at a particular cycle. It can be appreciated that several lithium salt additive compounds performed better than control.

### Example 6

### Characterization of Battery Cells Including Stabilizing Additives

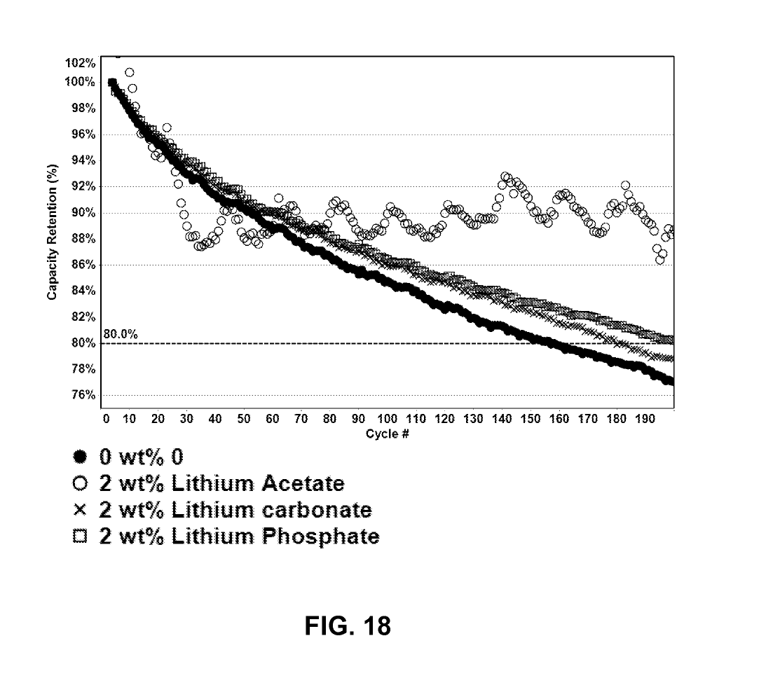

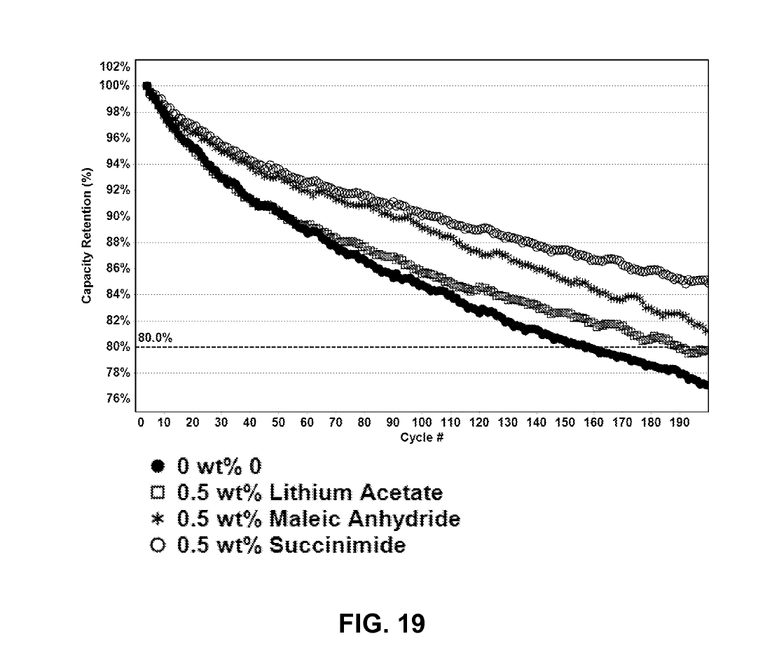

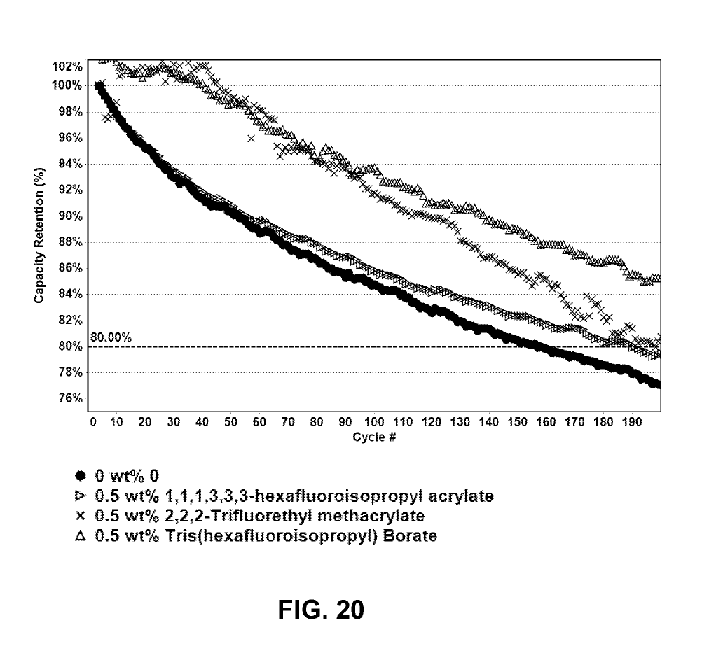

Using the methodology of Example 4, performance characteristics were measured for test battery cells including different stabilizing additives dispersed in a conventional electrolyte (ethylene carbonate, ethyl methyl carbonate, and 1M LiPF₆) and for a control battery cell including the conventional electrolyte but without a stabilizing additive. In this example, the cathode material was LMNO-type and the test was performed at room temperature. FIGS. 18 through 20 compare capacity retention of the battery cells over several cycles, expressed in terms of a percentage of an initial specific capacity upon discharge retained at a particular cycle. It can be appreciated that certain compounds performed better than control.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A battery comprising:
an anode comprising an anode active material characterized by a first specific capacity;
a cathode comprising a cathode active material characterized by a second specific capacity, wherein the first specific capacity and the second specific capacity are matched such that the battery is characterized by a rated charge voltage greater than about 4.2 V; and
an electrolyte comprising a lithium salt, a non-aqueous solvent, and an additive compound present at a concentration of no greater than about 5% of the total weight of the electrolyte wherein the battery is characterized by at least about a 15% reduction in residual current as compared to a control battery characterized by a rated charge voltage greater than about 4.2 V having a control electrolyte in which the additive compound is not present.

2. The battery of claim 1 wherein the battery is characterized by at least about a 45% reduction in residual current as compared to a control battery characterized by a rated charge voltage greater than about 4.2 V having a control electrolyte in which the additive compound is not present.

3. The battery of claim 1 wherein the battery is characterized by at least about a 60% reduction in residual current as compared to a control battery characterized by a rated charge voltage greater than about 4.2 V having a control electrolyte in which the additive compound is not present.

4. The battery of claim 1 wherein the battery and the control battery are compared at a temperature of about 50 degrees C.

5. The battery of claim 2 wherein the battery and the control battery are compared at a temperature of about 50 degrees C.

6. The battery of claim 3 wherein the battery and the control battery are compared at a temperature of about 50 degrees C.

7. The battery of claim 1 wherein the additive is selected from the group consisting of anhydride-containing compounds, ester-containing compounds, sulfone-containing compounds, nitrogen heteroaromatic compounds, phosphate-containing compounds, and borate-containing compounds.

8. The battery of claim 1 wherein the additive compound is present at a concentration of no greater than about 2% of the total weight of the electrolyte.

9. The battery of claim 1 wherein the additive compound is present at a concentration of no greater than about 0.5% of the total weight of the electrolyte.

10. The battery of claim 1 wherein the battery is characterized by a rated charge voltage greater than about 4.5 V.

11. The battery of claim 1 wherein the battery is characterized by a rated charge voltage greater than about 4.7 V.

12. The battery of claim 1 wherein the battery is characterized by a rated charge voltage greater than about 4.9 V.

13. A method of making a high voltage battery, comprising:
providing an electrolyte solution comprising a lithium salt, a non-aqueous solvent, and an additive compound present at a concentration of no greater than about 5% of the total weight of the electrolyte;
providing an anode comprising an anode active material characterized by a first specific capacity;
providing a cathode comprising a cathode active material characterized by a second specific capacity, wherein the first specific capacity and the second specific capacity are matched such that the battery is characterized by a rated charge voltage greater than about 4.2 V;
assembling the anode and cathode and optionally a separator into an electrochemical cell;
adding the electrolyte solution to the cell; and
sealing the cell to form the high voltage battery wherein the battery is characterized by at least about a 15% reduction in residual current as compared to a control battery characterized by a rated charge voltage greater than about 4.2 V having a control electrolyte in which the additive compound is not present.

14. The method of claim 13 wherein the battery is characterized by a rated charge voltage greater than about 4.5 V.

15. The method of claim 13 wherein the battery is characterized by a rated charge voltage greater than about 4.7 V.

16. The method of claim 13 wherein the battery is characterized by a rated charge voltage greater than about 4.9 V.

17. The method of claim 13 wherein the battery and the control battery are compared at a temperature of about 50 degrees C.

18. The method of claim 13 wherein the battery is characterized by at least about a 45% reduction in residual current as compared to a control battery characterized by a rated charge voltage greater than about 4.2 V having a control electrolyte in which the additive compound is not present.

19. The method of claim 13 wherein the battery is characterized by at least about a 60% reduction in residual current as compared to a control battery characterized by a rated charge voltage greater than about 4.2 V having a control electrolyte in which the additive compound is not present.

20. A method of using the battery of claim 1.
